(19) United States
(12) Patent Application Publication
(10) Pub. No.: US 2017/0019590 A1
(43) Pub. Date: Jan. 19, 2017

(54) IMAGING APPARATUS, INFORMATION PROCESSING APPARATUS, IMAGE PHOTOGRAPHING ASSIST SYSTEM AND IMAGE PHOTOGRAPHING ASSIST METHOD

(71) Applicant: FUJITSU LIMITED, Kawasaki-shi (JP)

(72) Inventor: Yasufumi NAKAMURA, Kawasaki (JP)

(73) Assignee: FUJITSU LIMITED, Kawasaki-shi (JP)

(21) Appl. No.: 15/278,001

(22) Filed: Sep. 27, 2016

Related U.S. Application Data
(63) Continuation of application No. PCT/JP2014/059329, filed on Mar. 28, 2014.

(51) Int. Cl. H04N 5/232; G06F 17/30; G06K 9/00

(52) U.S. Cl. CPC H04N 5/23222; H04N 5/23293; G06K 9/00228; G06F 17/3028

(57) ABSTRACT

An imaging apparatus includes a memory and a processor coupled to the memory. The processor is configured to perform transmitting an assist request for the imaging apparatus to an information processing apparatus, the information processing apparatus managing an image photographing skill on an individual basis and positional information of an apparatus associated with each of the individual, acquiring, from the information processing apparatus, assist information containing existence information of an image photographing enabled person within a predetermined range from the imaging apparatus, the assist information being generated based on the image photographing skill and the positional information, and outputting the acquired assist information to an output unit.

### CROSS-REFERENCE TO RELATED APPLICATION

This application is a continuation application of International Application PCT/JP2014/059329 filed on 28 Mar. 2014 and designated the U.S., the entire contents of which are incorporated herein by reference.

### FIELD

The embodiments discussed herein are related to an imaging apparatus, an information processing apparatus, an image photographing assist system, and an image photographing assist method.

### BACKGROUND

Advancements of an Information and Communication Technology (ICT) in recent years have led to a spread of imaging apparatuses instanced by a digital camera and a video camera, and there has been concomitantly an increase in opportunity of enjoying captured photos and videos. It is a general situation that portable information processing apparatuses instanced by a mobile phone, a smartphone, a tablet personal computer (PC) and a Personal Digital Assistant (PDA) have an imaging function. Therefore, a client (who will hereinafter be referred to as a user) of the information processing apparatus tends to have an increased opportunity of archiving photo-based records in the case of recording daily life events.

For example, at events instanced by travels and sports meetings in which a plurality of users participates, there is a tendency of image photographing subjects, i.e., the users participating in the events, printing the captured images to distribute the printed captured images to the participants afterward, and copying data of captured videos on recording mediums to send these copies to the participants afterward. It is also a general situation that a gathering is held by gathering the event participants to enjoy captured images and videos, or the participants mutually browse the captured images and videos by making use of e-mails, Social Networking Service (SNS) and other equivalent services.

It is to be noted that the following Patent documents exist as documents of the related arts describing technologies related to the technology that will be described in this specification.

### DOCUMENTS OF RELATED ARTS

[Patent Document]

[Patent document 1] Japanese Laid-open Patent Publication No. 2007-020104

[Patent document 2] Japanese Laid-open Patent Publication No. 2012-023501

[Patent document 3] Japanese Laid-open Patent Publication No. 2004-235783

### SUMMARY

An imaging apparatus includes a memory and a processor coupled to the memory. The processor is configured to perform transmitting an assist request for the imaging apparatus to an information processing apparatus, the information processing apparatus managing an image photographing skill on an individual basis and positional information of an apparatus associated with each of the individual, acquiring, from the information processing apparatus, assist information containing existence information of an image photographing enabled person within a predetermined range from the imaging apparatus, the assist information being generated based on the image photographing skill and the positional information, and outputting the acquired assist information to an output unit.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is an explanatory view for describing an image photographing assist system according to an embodiment;

FIG. 2A is a diagram illustrating an example of a hardware configuration of a computer;

FIG. 2B is an explanatory diagram of a functional configuration of the imaging apparatus according to the embodiment;

FIG. 2C is an explanatory diagram of a functional configuration of an information processing apparatus according to the embodiment;

FIG. 3 is an explanatory diagram of a functional configuration of an image photographing assist system according to the embodiment;

FIG. 4A is a diagram illustrating an image database DB;

FIG. 4B is a diagram illustrating a subject database DB;

FIG. 4C is a diagram illustrating a subject information database DB;

FIG. 4D is an explanatory diagram for describing subject areas of image information;

FIG. 4E is a diagram illustrating a subject sum-up information table;

FIG. 4F is a diagram illustrating an photographer information database DB;

FIG. 5A is a flowchart illustrating an image photographing assist process;

FIG. 5B is a flowchart of an image photographing process in S3 depicted in FIG. 5A;

FIG. 5C is a flowchart illustrating a subject sum-up process;

FIG. 5D is an explanatory diagram of an image photographing status of image photographing the subject;

FIG. 6A is a flowchart of an image photographing advice process in S2 illustrated in FIG. 5A;

FIG. 6B is a flowchart of a subject recognition process in S21 illustrated in FIG. 6A;

FIG. 6C is a flowchart of a face detection process in S41 illustrated in FIG. 6B;

FIG. 6D is a flowchart of the face detection process in S42 illustrated in FIG. 6B;

FIG. 6E is a flowchart of a proximity status detection process in S23 illustrated in FIG. 6A;

FIG. 6F is a flowchart of an image photographing status determination process in S25 illustrated in FIG. 6A;

FIG. 6G is a diagram illustrating an image photographing status information list;

FIG. 6H is a diagram illustrating a changeability list;

FIG. 6I is a flowchart of an image photographing advice notifying process in S26 illustrated in FIG. 6B;

FIG. 6J is a diagram illustrating an advice display count setting table;

FIG. 6K is a diagram illustrating an example of records of the changeability list extracted in a process of S91 illustrated in FIG. 6I;

FIG. 6L is a diagram illustrating an image photographing advice database DB;

FIG. 6M is a diagram illustrating an advice display method setting table; and

FIG. 7 is an explanatory diagram for describing a method of displaying an advice character string on the imaging apparatus.

### DESCRIPTION OF EMBODIMENTS

A user participating in the event can be a subject by a user's own imaging apparatus in a way that automatically photographs the user with, e.g., a self timer function or asks another participant to photograph the user by the imaging apparatus handed over to this participant. There is also such a case that when photographing the user participating in the event together with close acquaintances as participants or photographing all the participants, some other users are asked to photograph them.

For example, when there is a person having a skill enabling a nice photo to be photographed in consideration of a composition in the participants participating in the same event, in which case the participants tend to feel it desirable asking such the person to photograph the participants themselves. While on the other hand, there exists a case in which the participants feel it undesirable asking other users located nearby, who do not have acceptable photographing techniques, and such a case is assumed that the participants feel it preferable using the self timer function and other equivalent functions or selecting the photographer from within the participants and asking the selected photographer to photograph the image.

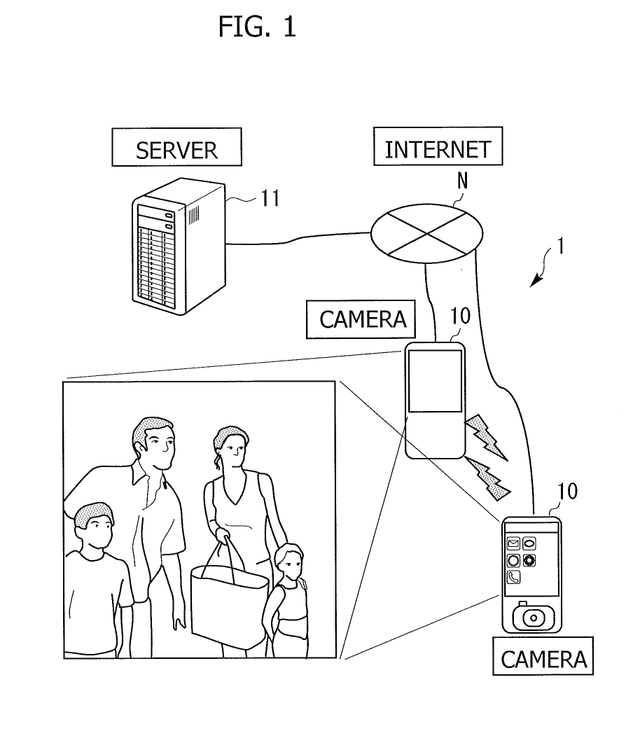

An imaging apparatus according to one embodiment will hereinafter be described with reference to the drawings. A configuration of the following embodiment is an exemplification, and the imaging apparatus is not limited to the configuration of the embodiment. The imaging apparatus will hereinafter be described based on the drawing of FIGS. 1 through 7.

### Example

### System Architecture

FIG. 1 illustrates an explanatory view of an image photographing assist system 1 according to the embodiment. The image photographing assist system 1 illustrated in FIG. 1 includes, e.g., an information processing apparatus 11 and an imaging apparatus 10, which are interconnected via a network N. The network N includes a public network instanced by the Internet, and a wireless network instanced by a mobile phone network. A plurality of imaging apparatuses 10 can be connected to the network N. The imaging apparatus 10 is an imaging apparatus instanced by a digital camera and a video camera, and has a communication function for establishing a connection to the network N. The imaging apparatus 10 includes a portable information processing apparatus having an imaging function and instanced by a mobile phone, a smartphone, a tablet PC and a PDA.

The information processing apparatus 11 is a computer instanced by a server and a PC. The information processing apparatus 11 includes a storage device equipped with a non-transitory storage medium that stores various categories of programs and a various items of data. The storage device is also called an external storage device. The storage device is exemplified by a solid-state drive, a hard disk drive and other equivalent storages. The storage device can include a portable non-transitory recording medium instanced by a Compact Disc (CD) drive a Digital Versatile Disc (DVD) drive, a Blu-ray (registered trademark) Disc (BD) drive and other equivalent drives. Note that the information processing apparatus 11 and the storage device may configure, e.g., part of cloud computing defined as a computer group on the network.

In the image photographing assist system 1 illustrated in FIG. 1, the information processing apparatus 11 collects image information of photos and videos captured by users of the imaging apparatuses 10 from the imaging apparatuses 10 connected via the network N like the Internet. The information processing apparatus 11 performs ranking to indicate an image photographing performance level (which will hereinafter be also termed a skill level) of capturing the photo on a user-by-user basis from, e.g., the collected image information. With respect to each of subject compositions of the collected image information, the information processing apparatus 11 calculates a subject frequency defined as an image photographing numerical quantity and a subject point taken account of a skill level of an photographer to the subject frequency per subject composition.

The information processing apparatus 11 of the image photographing assist system 1 detects, e.g., an image photographing opportunity for the imaging apparatus 10 of the user participating in, e.g., an event and other equivalents via the network N. The image photographing opportunity for the imaging apparatus 10 is detected by receiving, e.g., image information in process of being captured. In the image photographing assist system 1 illustrated in FIG. 1, the information processing apparatus 11 having detected video chance for the imaging apparatus 10 identifies the photographer and the subject contained in the subject composition from, e.g., the received image information in the process of being captured. The information processing apparatus 11 also specifies photographers of other imaging apparatuses located in a distance range in close proximity to the imaging apparatus 10 in the process of capturing the image. The information processing apparatus 11 acquires positional information of the imaging apparatuses 10 connected to the network N from other imaging apparatuses. The positional information of the imaging apparatuses 10 is acquired by, e.g., a Global Positioning System (GPS) function. The information processing apparatus 11 specifies other photographers located in the proximity distance range from relative distance relationships between the acquired positional information of the imaging apparatus 10 and other imaging apparatuses.

In the image photographing assist system 1 illustrated in FIG. 1, the information processing apparatus 11 recognizes an image photographing status in the process of the image being captured from pieces of information about the photographer identified from the received image information in the process of being captured, the subject contained in the subject composition, and the photographers of other imaging apparatuses. The information processing apparatus 11, with respect to a status in the case of changing the image photographing status in the process of the image being captured, generates changeability information containing point information in which the subject compositions before and after being changed, the skill level of the photographer, the skill levels of other photographers and other equivalent information.

The imaging apparatus 10 of image photographing assist system 1 illustrated in FIG. 1 generates advice information, based on the point information of the generated changeability information, for the photographer in the process of capturing the image. The advice information contains an advice for requesting one of other users to perform the image photographing, these users exhibiting high point values and being located in the proximity distance range of the imaging apparatus 10. The imaging apparatus 10 displays the generated advice information on a monitor and other equivalent display devices for displaying the image information in the process of being captured by a predetermined display method associated with the imaging apparatus 10. For example, the advice information is displayed on the monitor and other equivalent display devices by being superposed on the image information in the process of being captured.

The photographer of the imaging apparatus 10 requests, e.g., one of other users exhibiting high point values and being located in the proximity distance range of the imaging apparatus 10 to perform the image photographing on the basis of the advice information displayed by being superposed on the image information in the process of being captured, thereby enabling enhancement of a possibility of acquiring a well-performed result of the image photographing.

The image photographing assist system 1 according to the embodiment can provide the imaging apparatus 10 with the advice information taken account of the skill levels of the photographer and other photographers participating in the event, the subject composition and other equivalent elements, corresponding to the image photographing status in the process of the image being captured. It is therefore feasible to suggest, to the photographer, which photographer and what image photographing method are desirable for performing the image photographing, corresponding to the image photographing opportunity of the event and other equivalents. As a result, the imaging apparatus 10 of the image photographing assist system 1 can provide the technology of making the image photographing efficient and effective, and enhancing the possibility of acquiring the well-performed result of the image photographing, corresponding to the image photographing status in the process of the image being captured.

[Configuration of Apparatus]

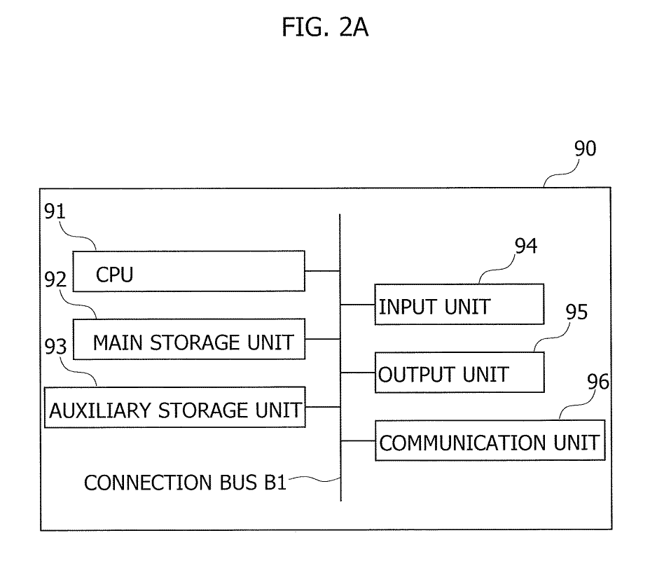

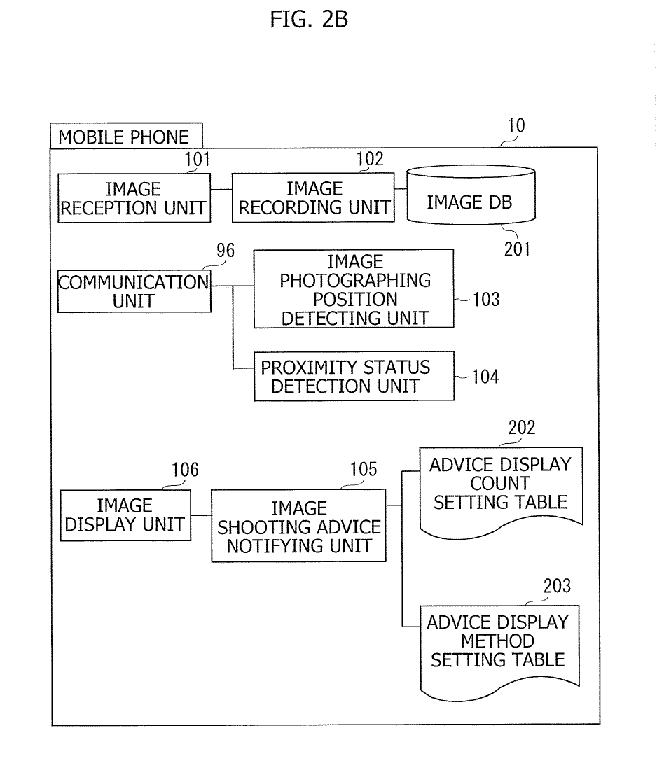

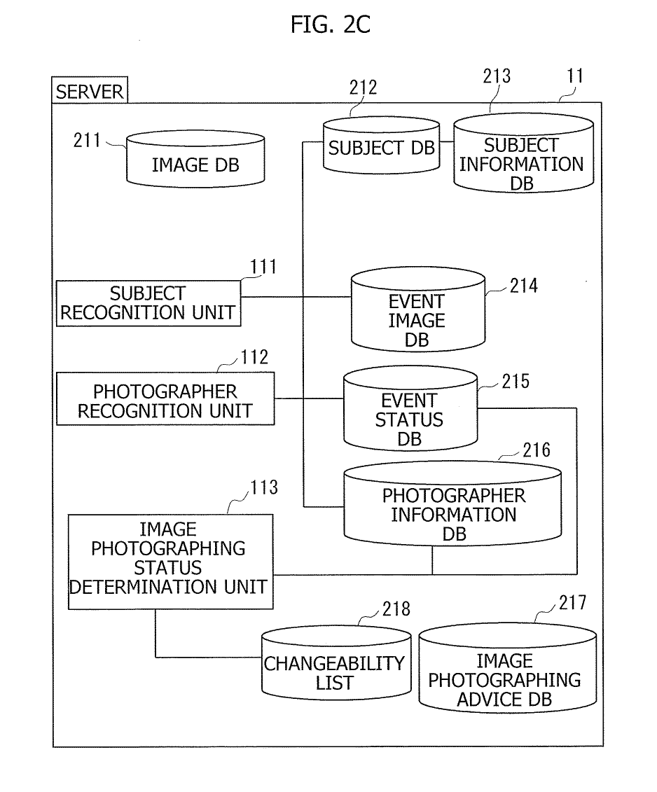

FIG. 2A illustrates a hardware configuration of an information processing apparatus 90. The information processing apparatus 90 illustrated in FIG. 2A has a configuration of a so-called general computer. The imaging apparatus 10 and the information processing apparatus 11 illustrated in FIG. 1 are attained by, e.g., the information processing apparatus 90 depicted in FIG. 2A.

The information processing apparatus 90 includes a Central Processing Unit (CPU) 91, a main storage unit 92, an auxiliary storage unit 93, an input unit 94, an output unit 95 and a communication unit 96, which are interconnected via a connection bus B1. The main storage unit 92 and the auxiliary storage unit 93 are non-transitory recording mediums readably by the information processing apparatus 90.

The information processing apparatus 90 is configured so that the CPU 91 deploys programs stored in the auxiliary storage unit 93 in an executable manner on a work area of the main storage unit 92, and controls peripheral devices by running the programs. The information processing apparatus 90 is thereby enabled to attain functions matching with predetermined purposes.

In the information processing apparatus 90 illustrated in FIG. 2A, the CPU 91 is a central processing unit for controlling the whole information processing apparatus 90. The CPU 91 executes processes based on the programs stored in the auxiliary storage unit 93. The main storage unit 92 is a storage medium on which the CPU 91 caches the programs and data, and deploys the work area. The main storage unit 92 encompasses, e.g., a Random Access Memory (RAM) and a Read Only Memory (ROM).

The auxiliary storage unit 93 stores the various categories of programs and various items of data on the recording medium in a readable/writable manner. The auxiliary storage unit 93 stores Operating System (OS), the various categories of programs, a variety of tables and other equivalent software. The OS contains a communication interface program for transferring and receiving the data to and from external equipment and other equivalent devices connected via the communication unit 96. The external equipment and other equivalent devices include other information processing apparatuses instanced by a server, other external storage devices and devices each having the communication function, which are connected on the network N.

The auxiliary storage unit 93 is exemplified by Erasable Programmable ROM (EPROM), an Solid State Drive (SSD), and a Hard Disk Drive (HDD). The auxiliary storage unit 93 can be further exemplified by a CD drive, a DVD drive and a BD drive. The non-transitory recording medium is exemplified by a silicon disk including a nonvolatile semiconductor memory (flash memory), the hard disk, the CD, the DVD, the BD, a Universal Serial Bus (USB) memory, and a memory card.

The input unit 94 accepts an operating instruction and other equivalents from a user and other equivalent person. The input unit 94 is exemplified by a pointing device instanced by an input button, a keyboard and a touch panel, and an input device instanced by a wireless remote controller, a microphone and a camera. The input unit 94 includes a variety of sensors instanced by a proximity sensor of infrared-rays and other equivalent types, a GPS receiver and other equivalent receivers. The CPU 91 is notified of the information inputted from the input unit 94 via the connection bus B1.

The output unit 95 outputs data to be processed by the CPU 91 and data to be stored in the main storage unit 92. The output unit 95 is an output device instanced by a Cathode Ray Tube (CRT) display, an Liquid Crystal Display (LCD), a Plasma Display Panel (PDP), an Electroluminescence (EL) panel, an organic EL panel, a printer and a speaker. The communication unit 96 is an interface with, e.g., the network N and other equivalents.

The CPU 91 reads, e.g., the OS, the various categories of programs and the various items of data stored in the auxiliary storage unit 93 into the main storage unit 92, and runs these software components, whereby the information processing apparatus 90 as the imaging apparatus 10 attains respective function units illustrated in FIG. 2B.

For example, the information processing apparatus 90 as the imaging apparatus 10 attains the functions as an image reception unit 101, an image recording unit 102, an image photographing position detecting unit 103, a proximity status detection unit 104, an image photographing advice notifying unit 105, and an image display unit 106, which are illustrated in FIG. 2B. The information processing apparatus 90 as the imaging apparatus 10 includes an image database DB 201, an advice display count setting table 202 and an advice display method setting table 203, which are built up as storage locations, in, e.g., the auxiliary storage unit 93, of the data which the foregoing respective function units refer to or are managed by the these function units.

The information processing apparatus 90 as the imaging apparatus 10, upon the foregoing function units being made to function, is thereby enabled to output the image information captured via the input unit 94 instanced by the camera to the network N and other equivalents. The imaging apparatus 10 can detect the image photographing opportunity for the subject via an user's operation on the input unit 94 instanced by the camera, acquire the positional information of the imaging apparatuses 10 by causing the GPS function and other equivalent functions to function, and output the acquired positional information to the network N. The imaging apparatus 10 can receive the advice for requesting the user exhibiting the high index value and being located in the proximity range to perform the image photographing via, e.g., the network N. The advice, received via the network N, for the image photographing opportunity is displayed on the output device included in the monitor, instanced by the EL panel, of the imaging apparatus 10. The user of the imaging apparatus 10 can receive the advice corresponding to the image photographing opportunity of the subject via the monitor instanced by the EL panel.

The CPU 91 reads, e.g., the OS, the various categories of programs and the various items of data stored in the auxiliary storage unit 93 into the main storage unit 92, and runs these software components, whereby the information processing apparatus 90 as the information processing apparatus 11 attains respective function units illustrated in FIG. 2C.

The information processing apparatus 90 as the information processing apparatus 11 attains functions as a subject recognition unit 111, a photographer recognition unit 112 photographer recognition unit 112 and an image photographing status determination unit 113, which are illustrated in FIG. 2C. The information processing apparatus 90 as the information processing apparatus 11 further includes an image database DB 211, a subject database DB 212, a subject information database DB 213, an event image database DB 214 and an event status database DB 215, which are built up as storage locations, in, e.g., the auxiliary storage unit 93, of the data which the foregoing respective function units refer to or are managed by the these function units. The information processing apparatus 90 as the information processing apparatus 11 still further includes a photographer information database DB 216 and an image photographing advice database DB 217 each built up in, e.g., the auxiliary storage unit 93. Note that the information processing apparatus 11 has a changeability list 218 and template data for specifying subject's facial features contained in a captured image in, e.g., the auxiliary storage unit 93.

The information processing apparatus 11, upon the foregoing function units being made to function, is thereby enabled to collect the image information captured from a plurality of imaging apparatuses 10 connected to, e.g., the network N. The information processing apparatus 11 can also specify, as a point, the skill level indicating the image photographing performance level per user of the imaging apparatus 10 from, e.g., the collected image information.

The information processing apparatus 11 can detect the image photographing opportunity for the subject from the plurality of imaging apparatuses 10 connected to the network N, and acquire the positional information of the respective imaging apparatuses 10. The information processing apparatus 11 can specify, for one imaging apparatus 10 having detected the image photographing opportunity, other imaging apparatuses 10 of the users exhibiting the high image photographing skills and being located in the proximity range of this one imaging apparatus 10, and give the advice for requesting any one of these users exhibiting the high image photographing skills to perform the image photographing.

Note that any one of the respective function units of the information processing apparatus 11 may be included in other information processing apparatuses. For example, the information processing apparatus including the subject recognition unit 111, the information processing apparatus including the photographer recognition unit 112 photographer recognition unit 112 and the information processing apparatus including the image photographing status determination unit 113, are interconnected via the network and other equivalents, and may thereby function as the information processing apparatus 11. Similarly, the respective databases DB of the information processing apparatus 11 are stored in distribution in a plurality of storage devices, and may also be interconnected via the network and other equivalents. The information processing apparatus 11 attains the respective function units by distributing these units to the plurality of information processing apparatuses, and is thereby enabled to reduce a processing load.

[Configuration of Function Blocks]

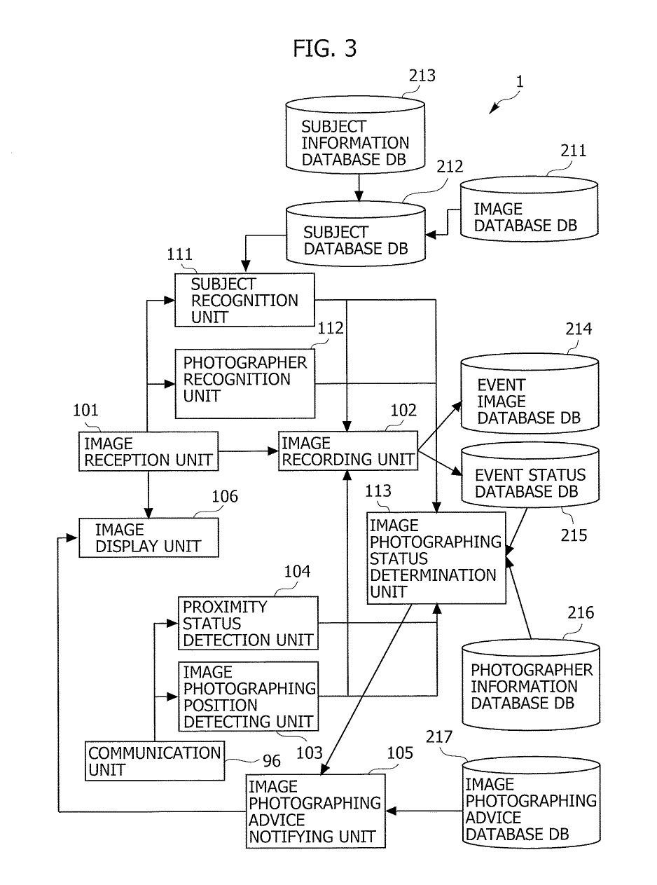

FIG. 3 illustrates an explanatory diagram of a configuration of functions generically as the image photographing assist system 1. The explanatory diagram illustrated in FIG. 3 represents a transition relationship between the configuration of the functions of the imaging apparatus 10 depicted in FIG. 2B and the configuration of the functions of the information processing apparatus 11 depicted in FIG. 2C.

In the explanatory illustrated in FIG. 3, the CPU 91 of the information processing apparatus 11 runs the computer program deployed in the executable manner on the main storage unit 92, thereby providing the subject recognition unit 111, the photographer recognition unit 112 photographer recognition unit 112 and the image photographing status determination unit 113. The same is applied to the image reception unit 101, the image recording unit 102, the image photographing position detecting unit 103, the proximity status detection unit 104, the image photographing advice notifying unit 105 and the image display unit 106 of the imaging apparatus 10. For example, the CPU 91 of the imaging apparatus 10 runs the computer program deployed in the executable manner on the main storage unit 92, thereby providing these function units.

In the explanatory illustrated in FIG. 3, the image database DB 211, the subject database DB 212, the subject information database DB 213, the event image database DB 214, the event status database DB 215, the photographer information database DB 216 and the image photographing advice database DB 217, are built up in, e.g., the auxiliary storage unit 93. Note that the auxiliary storage unit 93 equipped in the information processing apparatus 11 includes the changeability list 218 and the template data for specifying subject's facial features contained in the captured image. Note that the template data contain plural sizes of data. The information processing apparatus 11 of the image photographing assist system 1 executes processes assigned to the respective function units, which refer to or manage the data of the respective databases DB built up as the data storage locations in the auxiliary storage unit 93.

(Imaging Apparatus 10)

In the explanatory illustrated in FIG. 3, the image reception unit 101 accepts the image information in the process of being captured by an imaging device of the imaging apparatus 10 instanced by the camera. The image information contains a plurality of subjects as image photographing targets. The subject composition is set by an arrangement, positions, posing and other equivalent elements of the subjects within the image information. The image information in the process of being captured, which is accepted by the image reception unit 101, is temporarily stored in a predetermined area of the main storage unit 92 of the imaging apparatus 10 together with such items of image photographing information as Exchangeable image file format (Exif). Herein, “Exif” is defined as attribute information added to the image information captured by a digital camera and other equivalent imaging equipment, and is a standard that is standardized by Japan Electronics and Information Technology Industries Association (JETTA).

The exif information contains, for example, an image photographing date/time, a model name of the imaging apparatus 10, a maker name, a resolution, a shutter speed, a stop, an image photographing mode and a focal length and so on. In the case of having an electronic compass and the GPS function, the Exif information contains a photographing direction and positional information instanced by a latitude, a longitude and an altitude.

The image reception unit 101 hands over the image information in the process of being captured to the image recording unit 102 and the image display unit 106 of the imaging apparatus 10. The image reception unit 101 transmits the image information in the process of being captured to the connection-established network N via the communication unit 96 of the imaging apparatus 10. The information processing apparatus 11 connected to, e.g., the network N receives the image information in the process of being captured, which is transmitted to the network N. The image information, which is received by the information processing apparatus 11, is handed over to the subject recognition unit 111 and the photographer recognition unit 112 photographer recognition unit 112 of the information processing apparatus 11.

The image recording unit 102, upon being triggered by, e.g., a user's operation on an operation input button like a shutter button included in the input unit 94, records the image information in the process of being captured, which is handed over from the image reception unit 101, as image data. The image recording unit 102 stores the image information in the process of being captured as image record in, e.g., the image database DB 201 built up in the auxiliary storage unit 93 of the imaging apparatus 10 illustrated in FIG. 2B. For example, The image recording unit 102 stores attached information related to the image photographing opportunity at the event together with the image information in the process of being captured, which is handed over from the image reception unit 101, in the event image database DB 214 and the event status database DB 215 each connected to the network N. For example, the image recording unit 102 stores the image information in the process of being captured in the event image database DB 214 and the attached information related to the image photographing opportunity at the event in the event status database DB 215.

Herein, the attached information contains subject information recognized by the subject recognition unit 111 of the information processing apparatus 11 connected via the network N and photographer information recognized by the photographer recognition unit 112 photographer recognition unit 112 thereof. The subject information is specified based on the image information in the process of being captured, which is transmitted from the image reception unit 101 of the imaging apparatus 10. The photographer information is specified based on information for identifying the imaging apparatus 10, the image information acquired by capturing an image of the photographer and so on.

The attached information further contains, e.g., the positional information of the imaging apparatuses 10 detected by the image photographing position detecting unit 103, and information about other imaging apparatuses located in the proximity distance range of the imaging apparatus 10, which is detected by the proximity status detection unit 104. Note that the attached information may contain bearing information in an image photographing direction detected by an electronic compass function and other equivalent functions when the imaging apparatus 10 has the electronic compass function and other equivalent functions.

Note that the image information contains the Exif information, in which case, e.g., the image recording unit 102 may store the image information containing the Exif information in the event image database DB 214, and may also store the attached information and the Exif information as reference information in the event status database DB 215. The image photographing assist system 1, after distinguishing between the storage location of the image record containing the image information and the storage location of the reference information related to the event, shares the information stored in the event status database DB 215 as information for unitarily managing the event image photographing statuses related to the image photographing opportunities among participants. The shared information stored in the event status database DB 215 does not contain any tangible image records, and hence it does not happen that the image information of the photos, the videos and other equivalents, which are undesirable for being browsed by other participants, is carelessly shared among other participants.

The image photographing position detecting unit 103 detects the positional information of the imaging apparatuses 10 in the process of capturing the image information. When the imaging apparatus 10 has the GPS function, the image photographing position detecting unit 103 causes, e.g., the GPS function to function, and detects the latitude and the longitude as the positional information of the imaging apparatus 10. Note that the positional information of the imaging apparatuses 10 may also be detected based on a distance from a wireless base station for a mobile phone network and other equivalent networks covered by the network N to which the imaging apparatus 10 is connected. The image photographing position detecting unit 103 temporarily stores the detected positional information of the imaging apparatuses 10 in, e.g., a predetermined area of the main storage unit 92. The image photographing position detecting unit 103 hands over the detected positional information of the imaging apparatuses 10 to the image recording unit 102, and also to the image photographing status determination unit 113 of the information processing apparatus 11 connected to the network N via the communication unit 96.

Note that when the imaging apparatus 10 has the electronic compass function and other equivalent functions, the image photographing position detecting unit 103 may also acquire the bearing information of the detected image photographing direction via the electronic compass function and other equivalent functions. The bearing information can be expressed by a relative angle in a range of 0-360 degrees, in which the relative angle to the true north is set to “0 degree” clockwise. The acquired the bearing information of the image photographing direction of the imaging apparatus 10 is handed over to, e.g., the image recording unit 102 and the image photographing status determination unit 113 of the information processing apparatus 11 connected to the network N.

The proximity status detection unit 104 detects other imaging apparatuses located in the proximity distance range from the imaging apparatus 10 related to the image photographing opportunity for the image information. For example, the proximity status detection unit 104 acquires a list of the positional information of other imaging apparatuses of the users participating in the event from the information processing apparatus 11 connected to the network N. The proximity status detection unit 104 calculates relative distances from other imaging apparatuses on the basis of the acquired positional information of other imaging apparatuses and the positional information detected by the image photographing position detecting unit 103. The proximity status detection unit 104 detects other imaging apparatuses located in the proximity distance range from the imaging apparatus 10 from a magnitude relationship of the relative distances between the imaging apparatus 10 and other imaging apparatuses.

The proximity status detection unit 104 generates a list of proximity apparatuses in the sequence from, e.g., the smallest (closest of relative distances) of calculated relative distance values, and temporarily stores the proximity apparatus list in a predetermined area of the main storage unit 92. Note that when generating the proximity apparatus list, a threshold value for determining the magnitudes of the relative distance values may be provided. For example, the proximity status detection unit 104 may also generate the proximity apparatus list for other imaging apparatuses having the relative distance values that are smaller than the threshold value. The threshold value for determining the magnitudes of the relative distance values, whereby the plurality of imaging apparatuses 10 can be narrowed down. Herein, the threshold value for determining the magnitudes of the relative distance values is an arbitrary value and can be set corresponding to a scale, a place, time, a number of participants in the event, and other equivalent elements of the event.

The proximity status detection unit 104 transmits the generated proximity apparatus list to, e.g., the image photographing status determination unit 113 of the information processing apparatus 11 connected to the network N via the communication unit 96. Note that the function of the proximity status detection unit 104 may be included in, e.g., the information processing apparatus 11. For example, the information processing apparatus 11 collects the positional information of the plurality of the imaging apparatuses 10 participating in the event and connected to the network N. It may be sufficient that the information processing apparatus 11 calculates the relative distance values between the imaging apparatus 10 related to the image photographing opportunity and other imaging apparatuses on the basis of the collected positional information per imaging apparatus 10. It may be also sufficient that the information processing apparatus 11 generates the proximity apparatus list of other imaging apparatuses with respect to the imaging apparatus 10 related to the image photographing opportunity on the basis of the calculated relative distance values, and hands over the generated proximity apparatus list to the image photographing status determination unit 113. The information processing apparatus 11 includes the function of the proximity status detection unit 104, thereby enabling the processing load on the imaging apparatus 10 to be reduced.

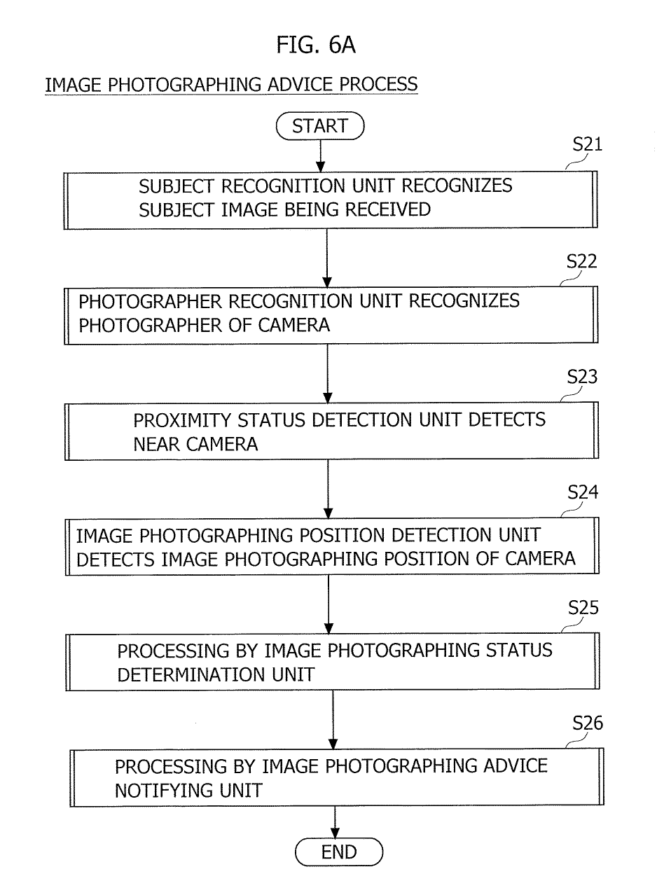

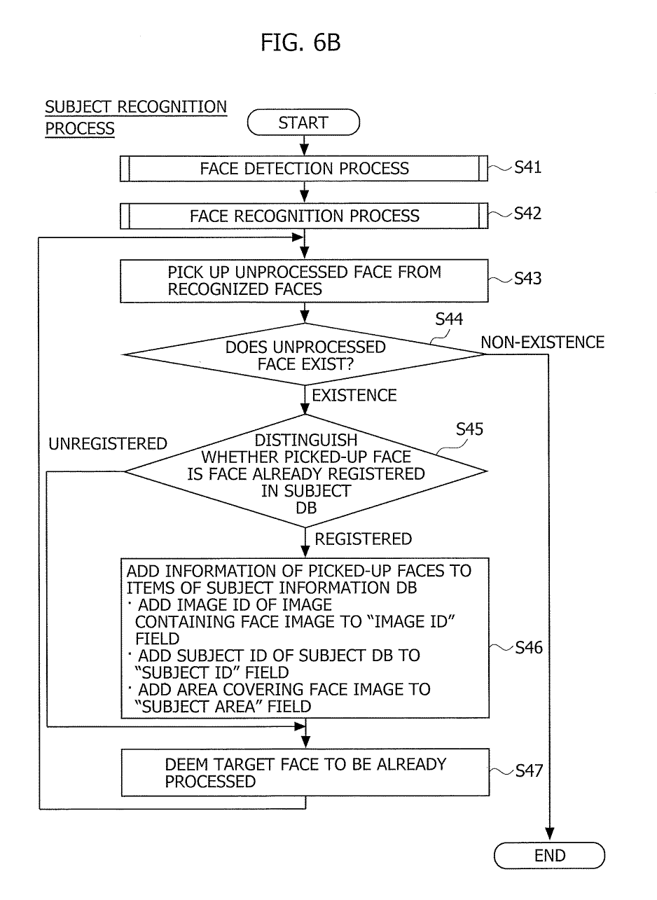

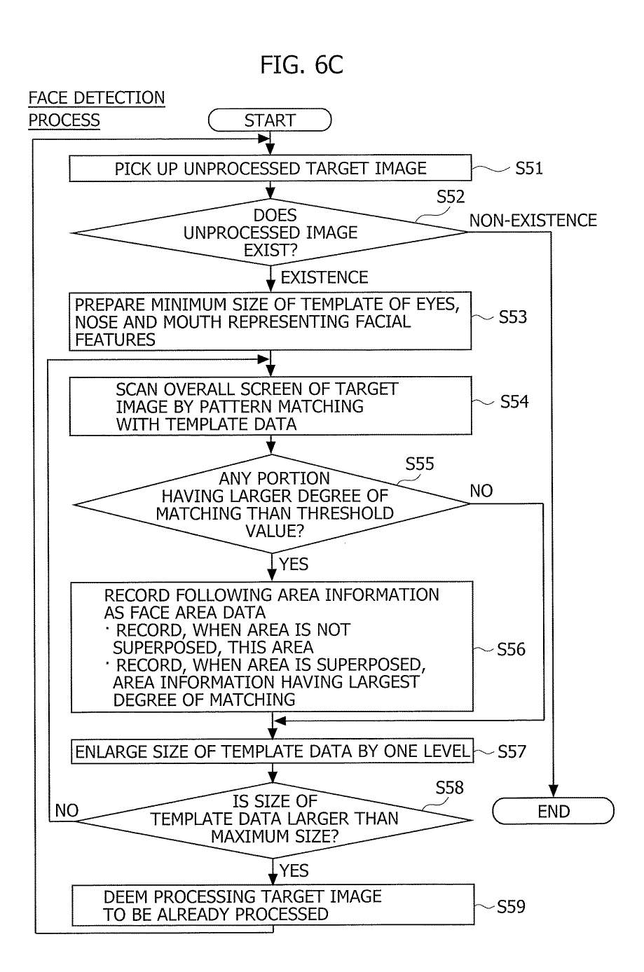

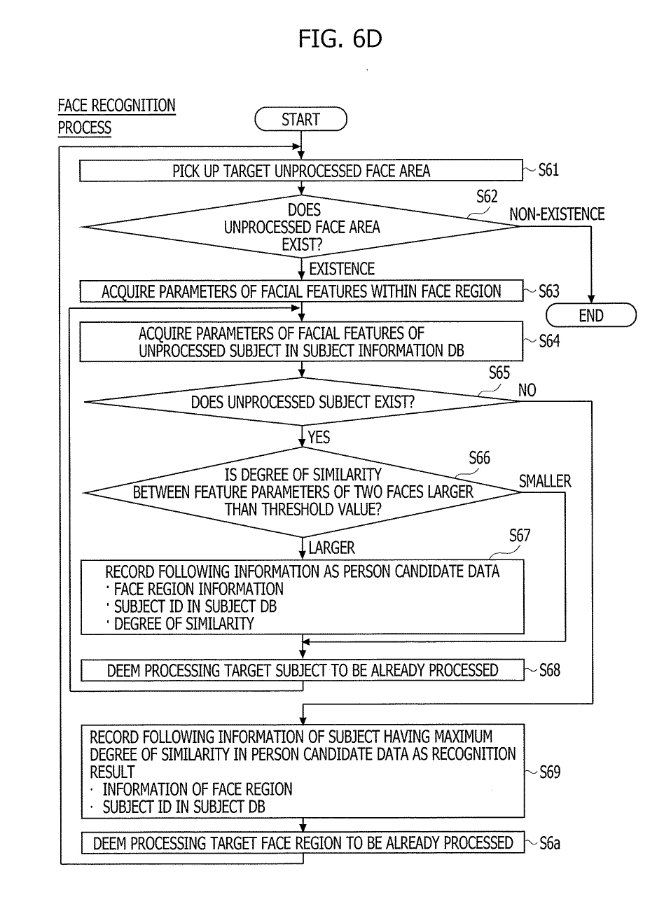

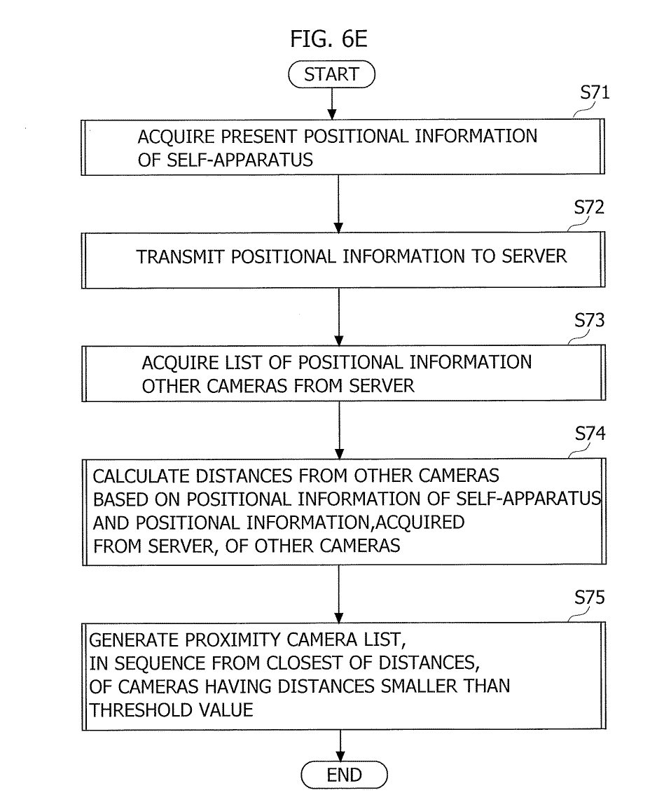

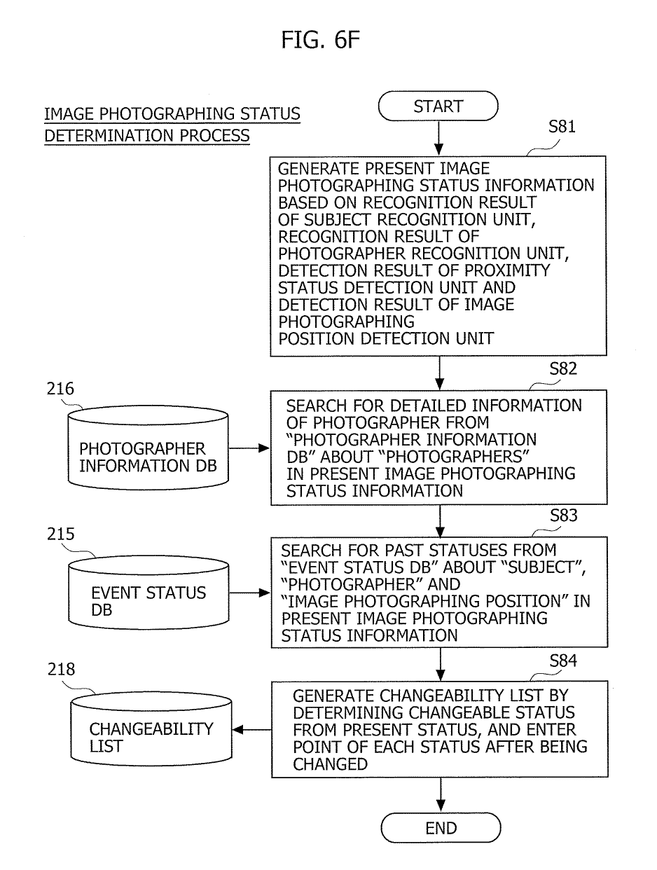

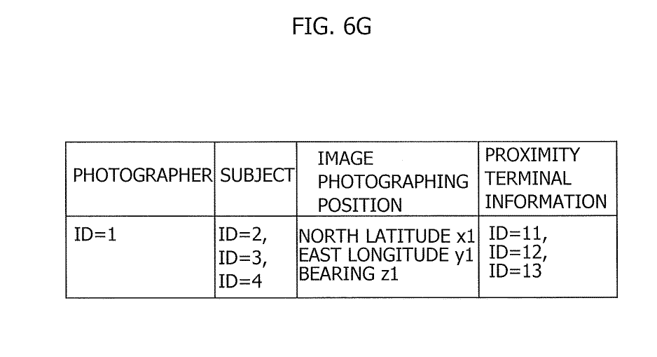

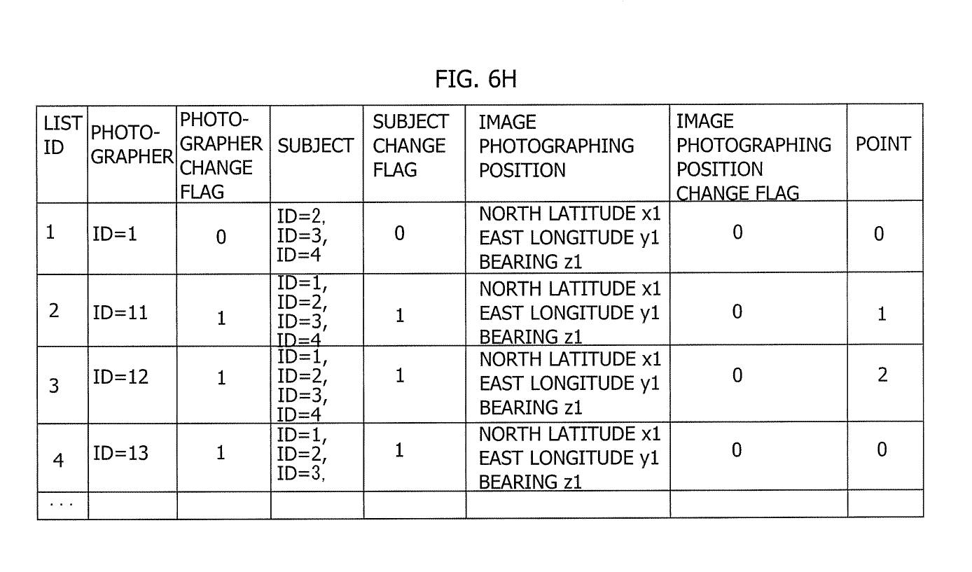

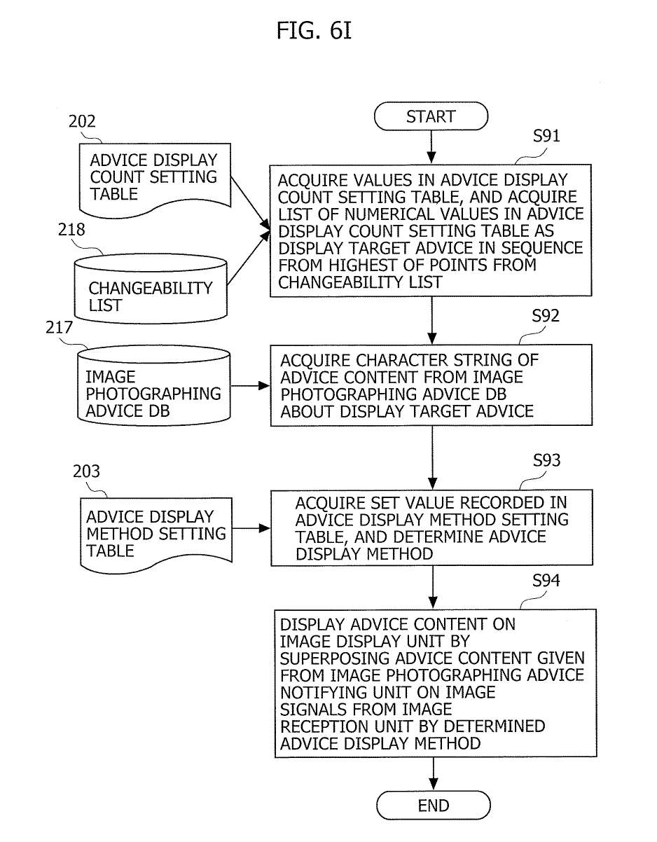

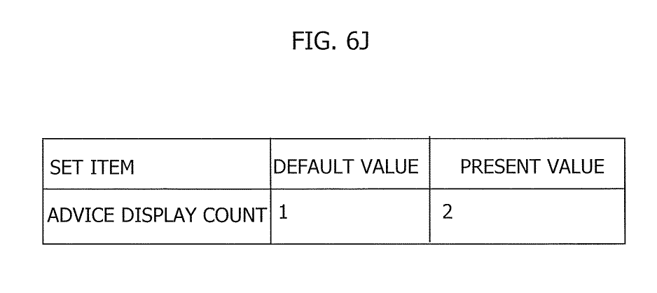

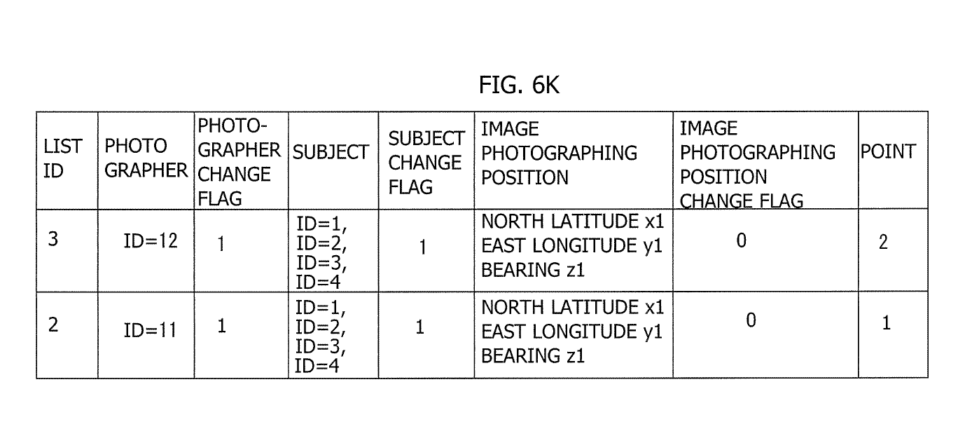

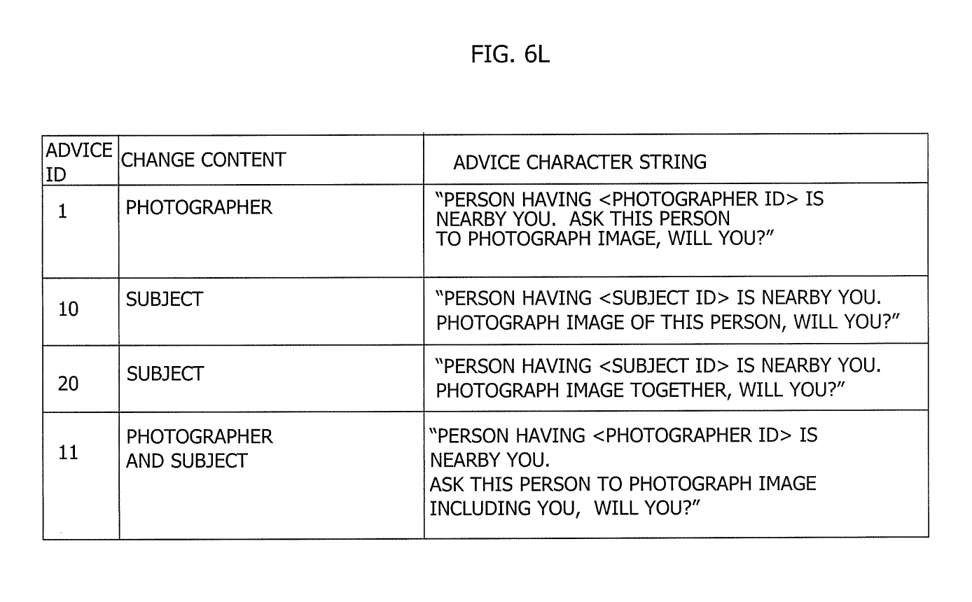

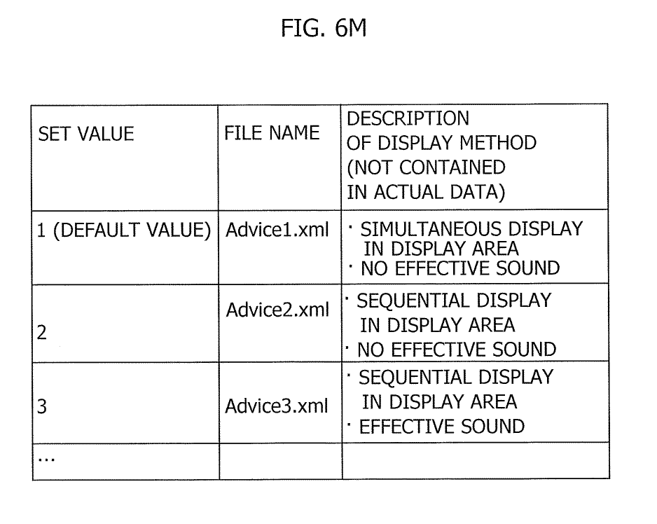

The image photographing advice notifying unit 105 refers to the image photographing advice database DB 217, corresponding to the changeability information with respect to the image photographing status in the process of the image being captured, which is notified from the image photographing status determination unit 113, and thus specifies the advice information for the image photographing method about the subject composition and other equivalent elements in the process of capturing the image. The advice information contains, e.g., an image photographing request for other photographers (image photographing enabled persons) exhibiting the high skill levels, who are in close proximity to the photographer concerned. The image photographing advice notifying unit 105 temporarily stores the advice information specified by referring to the image photographing advice database DB 217 in a predetermined area of the main storage unit 92, and hands over the advice information to the image display unit 106. Note that an in-depth description of an image photographing advice notifying process by the image photographing advice notifying unit 105 will be made in FIG. 6I.

The image display unit 106 displays the image information, related to the image photographing opportunity, in the process of capturing the image, which is handed over from the image reception unit 101, on the display device for the monitor like the EL panel of the output unit 95 equipped in the imaging apparatus 10. The image display unit 106 displays, e.g., attribute information related to the image photographing, such as the Exif information contained in the image information on the display device for the monitor by being superposed on the image data in the process of capturing the image. The image display unit 106 similarly displays, e.g., the advice information related to the image photographing method, which is handed over from the image photographing advice notifying unit 105, on the display device for the monitor by being superposed on the image data in the process of capturing the image. The advice information specified by the image photographing advice notifying unit 105 and related to the image photographing opportunity in the process of capturing the image, is displayed to the user of the imaging apparatus 10 through the display device for the monitor.

(Information Processing Apparatus 11)

In the explanatory diagram illustrated in FIG. 3, the subject recognition unit 111 analyzes the image information in the process of being captured, which is transmitted from the imaging apparatus 10 via the network N, and thus recognizes the subjects in the subject composition, the subjects being deemed to be targets in the image photographing opportunity of the imaging apparatus 10. The recognition of the subject is processed by, e.g., a face recognition technology. The subject recognition unit 111 receives the image information in the process of being captured, which is transmitted from the imaging apparatus 10 via, e.g., the network N, and temporarily stores the image information in a predetermined area of the main storage unit 92. The subject recognition unit 111 detects a face of each of the subjects in the subject composition from the image data of the received image information, and specifies a facial region. The subject recognition unit 111 executes a face recognition process about the specified facial region. An in-depth description of the subject recognition process by the subject recognition unit 111 will be made in FIG. 6C.

The subject recognition unit 111 refers to, e.g., the image database DB 211, the subject database DB 212 and the subject information database DB 213, and checks the image-captured region of the specified subject's face against face information contained in the recorded videos-photos stored in the image database DB 211 by pattern matching and other equivalent techniques. The subject recognition unit 111, for instance, when a matching degree is equal to or larger than a predetermined threshold value as a result of checking, recognizes that the subject contained in the image information in the process of being captured is a subject registered in the subject database DB 212. Whereas when the matching degree is smaller than the predetermined threshold value as the result of the checking, the subject recognition unit 111 recognizes that the subject contained in the image information in the process of being captured is a subject not registered in the subject database DB 212.

The subject recognition unit 111, e.g., when recognizing that the subject contained in the image information in the process of being captured is registered in the subject database DB 212, transmits subject information registered in the subject database DB 212 to the imaging apparatus 10 connected to the network N via the communication unit 96. Herein, the subject information contains, e.g., a subject ID for uniquely identifying the subject, and a subject name registered in the subject database DB 212. The image recording unit 102 is notified of the subject information received by the imaging apparatus 10. The subject recognition unit 111, e.g., when recognizing that the subject contained in the image information in the process of being captured is registered in the subject database DB 212, hands over the subject information registered in the subject database DB 212 to the image photographing status determination unit 113.

Note that when recognizing that the subject contained in the image information in the process of being captured is not registered in the subject database DB 212, there is no particular limit to the notifying process to the imaging apparatus 10. For example, the subject recognition unit 111 may notify the imaging apparatus 10 of a specific ID for indicating that the subject contained in the image information in the process of being captured is not registered in the subject database DB 212. The image recording unit 102 of the imaging apparatus 10 receiving the notification of the specific ID causes the specific ID to be contained as the subject information in the attached information, and can record the captured image information. The image recording unit 102 of the imaging apparatus 10 may also, e.g., record the captured image information without containing the subject information in the attached information. The same is applied to the subject composition that is handed over to the image photographing status determination unit 113, and, for instance, the subject recognition unit 111 can hand over, as the subject information, the specific ID for indicating that the subject contained in the image information in the process of being captured is not registered in the subject database DB 212.

The photographer recognition unit 112 photographer recognition unit 112 specifies the photographer in the process of capturing the image based on the information for identifying the imaging apparatus 10, e.g., the information acquired when performing the communication with the imaging apparatus 10 and the information acquired when receiving the image information. The photographer recognition unit 112 photographer recognition unit 112 can specify the photographer from, e.g., address information and other equivalent information related to the communications of the imaging apparatus 10 that transmits the image information. It may be sufficient that the photographer recognition unit 112 photographer recognition unit 112 previously retains, in the auxiliary storage unit 93, e.g., an photographer list and other equivalent lists structured so that the address information related to the communications of the imaging apparatus 10 is associated with the user (photographer) having the address information. Associative relationship between the address information related to the communication and the user may be generated, e.g., when the image photographing assist system 1 registers the image information in the information processing apparatus 11. It may be sufficient that the photographer recognition unit 112 photographer recognition unit 112, e.g., when receiving the image information in the process of being captured, which is transmitted from the imaging apparatus 10 via the network N, refers to the photographer list and other equivalent lists retained in the auxiliary storage unit 93 and other equivalent storages, and associates the address information related to the communications with the user.

The imaging apparatus 10 is equipped with a plurality of imaging devices instanced by an in-camera for capturing an image of the photographer and an out-camera for capturing an image of the subject, in which case the photographer may also be specified by using the image information captured by the camera located on the side of the photographer. For example, the photographer recognition unit 112 photographer recognition unit 112 can specify, as in the description of the subject recognition unit 111, the photographer by applying the face recognition technology to the image information of the imaging apparatus 10. It may be sufficient that the photographer recognition unit 112 photographer recognition unit 112, for example, similarly to the subject recognition unit 111, checks the image-captured region of the subject's face specified from the image data of the received image information against the face information of the recorded videos-photos stored in the image database DB 211 by the pattern matching and other equivalent techniques. The photographer recognition unit 112 photographer recognition unit 112 may simply specify the photographer contained in the image information as an photographer registered in the subject database DB 212 when the matching degree therebetween is equal to or larger than the predetermined threshold value.

The photographer recognition unit 112 photographer recognition unit 112 transmits the photographer information specified based in the image information transmitted from the imaging apparatus 10 to the imaging apparatuses 10 connected to the network N via, e.g., the communication unit 96. Herein, the photographer information contains, e.g., an photographer ID for uniquely identifying the photographer and names of the photographers registered in the photographer information database DB 216 and other equivalent databases. For example, the image recording unit 102 is notified of the photographer information received by the imaging apparatus 10. The photographer recognition unit 112 photographer recognition unit 112 hands over the specified photographer information to, e.g., the image photographing status determination unit 113.

The image photographing status determination unit 113 recognizes the image photographing status related to the image photographing opportunity of the event from the image information in the process of being captured, which is transmitted from the imaging apparatus 10. The image photographing status determination unit 113 collects the subject information recognized by the subject recognition unit 111 and the photographer information specified by the photographer recognition unit 112. The image photographing status determination unit 113 collects the positional information of the imaging apparatuses 10 with their photographing positions being detected by the image photographing position detecting unit 103 and the proximity apparatus list generated by the proximity status detection unit 104 via the network N.

The image photographing status determination unit 113 specifies the skill levels representing the image photographing performance levels of the photographer in the image information in the process of being captured and of other photographers participating in the event by referring to, e.g., the various items of collected information and the photographer information database DB 216. The image photographing status determination unit 113 further specifies a past image photographing frequency, the subject point and other equivalent elements with respect to the subject composition of the image information in the process of being captured by referring to, e.g., the various items of collected information and the event status database DB 215. The image photographing status determination unit 113 generates the changeability list 218 by associating the image photographing status in the process of the image being captured with a point in the case of the image photographing status being changed. The image photographing status determination unit 113 transmits, e.g., the generated changeability list 218 or notification of completing the generation of the changeability list 218 to the imaging apparatus 10 that transmits the image information in the process of being captured. Note that an in-depth description of an image photographing status determination process executed by the image photographing status determination unit 113 will be made in FIG. 6F.

The changeability list 218 or the notification of completing the generation of the changeability list 218, which are transmitted from the image photographing status determination unit 113, are received by, e.g., the image photographing advice notifying unit 105 of the imaging apparatus 10 connected to the network N. The image photographing advice notifying unit 105 of the imaging apparatus 10 refers to the image photographing advice database DB 217 on the basis of the received information, thereby specifying the advice information to be displayed on the display device for the monitor instanced by the EL panel equipped in the imaging apparatus 10. Note that the advice information specified by the image photographing advice notifying unit 105 contains a plurality of advices.

[Structure of Database]

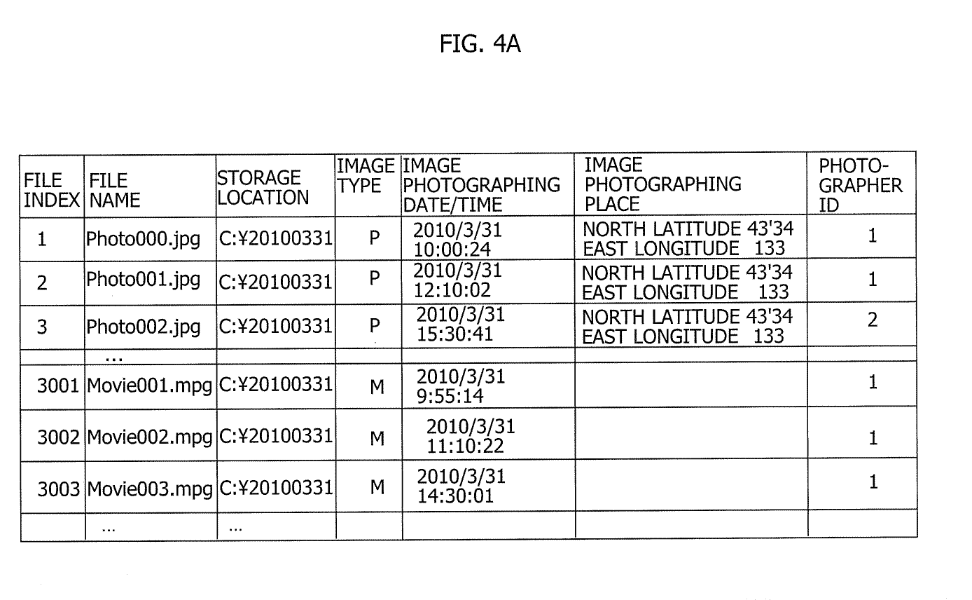

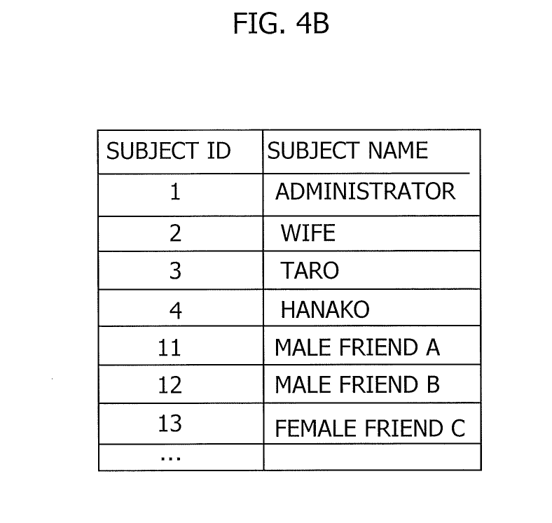

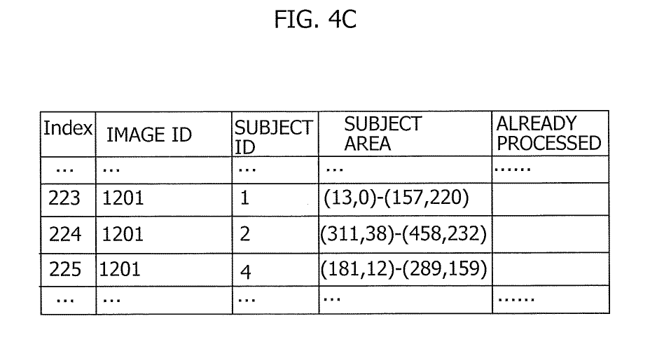

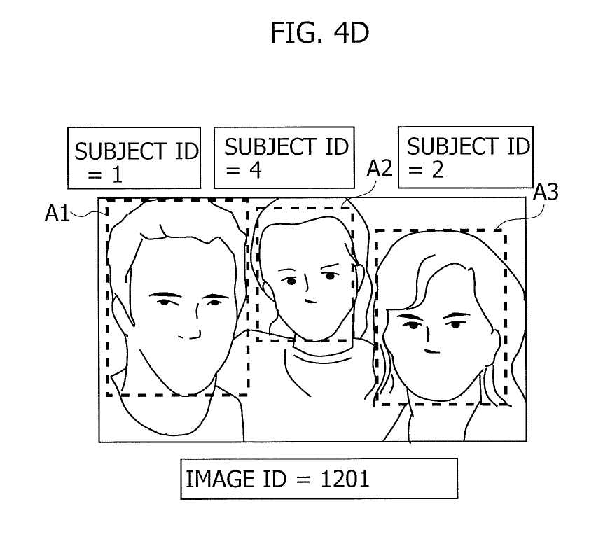

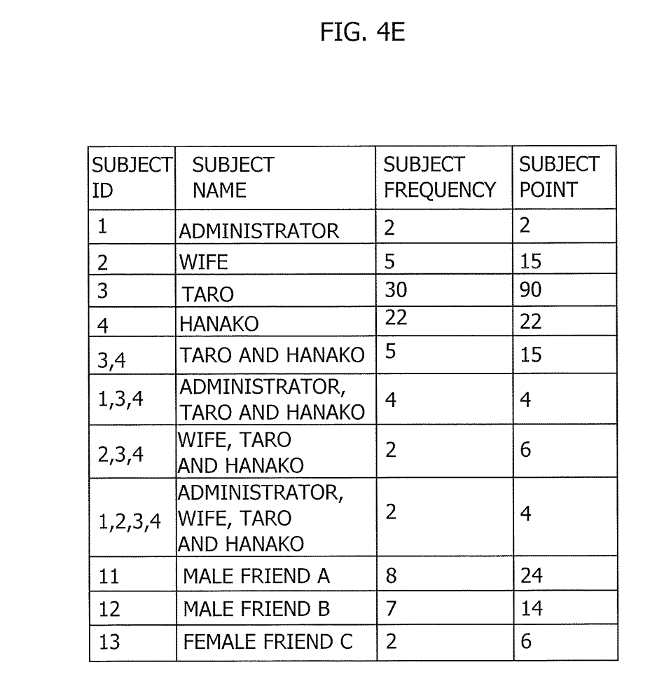

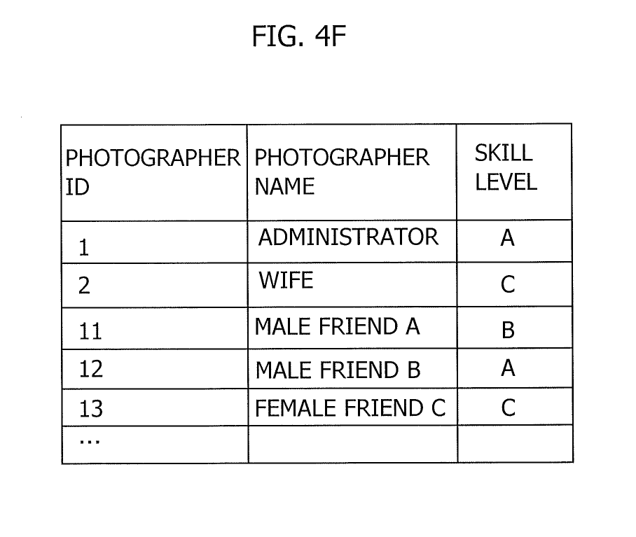

FIG. 4A illustrates one example of the image database DB 211. The image information collected by and accumulated in the information processing apparatus 11 of the image photographing assist system 1 according to the embodiment is stored in the image database DB 211. The image information collected and accumulated in the image database DB 211 contains, e.g., items of image information on an event-by-event basis, which are captured by the imaging apparatus 10. Note that the items of image information on the event-by-event basis are stored in, e.g., a format illustrated in FIG. 4A in the event image database DB 214.

The image database DB 211 illustrated in FIG. 4A has fields such as a “file Index” field, a “file name” field, a “storage location” field, a “image type” field, a “image photographing date/time” field, a “image photographing place” field and a “photographer ID” field. The identifying information for uniquely identifying the image information on the event-by-event basis, which is captured by the imaging apparatus 10, is stored in the “file Index” field. Pieces of identifying information stored in the “file Index” field are automatically allocated with serial numbers by, e.g., an administrator for administering the image photographing assist system 1 or by the information processing apparatus 11. A file name of the image information captured by the imaging apparatus 10 is stored in the “file name” field. A path to a folder stored with the file name of the image information captured by the imaging apparatus 10 is stored in the “storage location” field. For example, the folder stored with the image information contains a folder, for storing the image information, provided in the auxiliary storage unit 93 of the imaging apparatus 10.

A type of the image information captured by the imaging apparatus 10 is stored in the “image type” field. In the example of FIG. 4A, for instance, “P” is entered in the “image type” field when the captured image information is a static image instanced by a photo, while “M” is entered when being a moving image instanced by a video. The type of the image information can be specified by, e.g., an extension instanced by “.jpg” and “.mpg” of the file name of the image information stored in the “file name” field. The information processing apparatus 11 may also determine the type of the image information stored in the “image type” field from, e.g., the extension of the image information stored in the “file name” field.

Image photographing date/time of the image information captured by the imaging apparatus 10 is stored in the “image photographing date/time” field. The image photographing date/time stored in the “image photographing date/time” field can be exemplified by a mode of timestamping time information indicating a 2-digit time, a 2-digit minute and a 2-digit second in addition to a 4-digit calendar year, a 2-digit calendar month and a 2-digit calendar date. The image photographing date/time can be specified from a timestamp attached to the Exif information or the file contained in the image information.

The positional information of the image photographing place of the image information captured by the imaging apparatus 10 is stored in the “image photographing place” field. The positional information stored in the ‘image photographing place” field contains, e.g., the latitude/longitude information of the image photographing place acquired via the GPS function.

Note that the positional information stored in the “image photographing place” field may contain positional information using a positional relationship with the communication base station for establishing the connection to the network N, and the altitude/longitude positional information acquired by designating the image photographing place on a map may also be stored in the “image photographing place” field.

Photographer identifying information (photographer ID) for uniquely identifying the photographer of the image information captured by the imaging apparatus 10, is stored in the “photographer ID” field. The photographer identifying information stored in the “photographer ID” field is, e.g., the identifying information registered when registering the user of the image photographing assist system 1. The photographer ID is associated with, e.g., the address information related to the communications of the imaging apparatus 10, in which case the address information may be stored therein.

In the example of FIG. 4A, in a record specified by “3” entered in the “file Index” field, “Photo002.jpg” is entered in the “file name” field, and “C:¥20100331” indicating a path of the folder stored with the file “Photo002.jpg” is entered in the “storage location” field. Further, “P” indicating the type of the captured image information is entered in the “image type” field, and “2010/3/31 15:30:41” indicating the image photographing date/time of the image information is entered in the “image photographing date/time” field. A value “north latitude: 43′34, east longitude: 133” indicating the information of the position in which the image information is captured, is entered in the “image photographing place” field, and a value “2” identifying the user who captures the image information is entered in the “photographer ID” field.

FIG. 4B illustrates one example of the subject database DB 212. The subject database DB 212 is stored with subject identifying information (subject ID) for uniquely identifying the subject contained in the image information stored in the image database DB 211 and the subject name by being associated with each other. Note that associative relationship between the image information stored in the image database DB 211 and the subject identifying information stored in the subject database DB 212 is managed by the subject information database DB 213.

As illustrated in FIG. 4B, the subject database DB 212 has a “subject ID” field and a “subject name” field. the subject identifying information for identifying the subject is stored in the “subject ID” field. A name and other equivalent information of the subject is stored in the “subject name” field. Note that the information stored in the “subject name” field may also be, e.g., any “naming” distinguishable by the photographer and other equivalent persons of the image information stored in the image database DB 211. For example, after capturing the image information containing the subject, the photographer or another equivalent person refers to the captured image information and can register the name in the “subject name” field. In the example of FIG. 4B, in a record specified by, e.g., “11” entered in the “subject ID” field, a naming such as “male friend A” is entered in the “subject name” field. Note that in a record specified by “1” entered in the “subject ID” field, a naming such as “administrator” given to the photographer who captures the image information is entered in the “subject name” field.

FIG. 4C illustrates one example of the subject information database DB 213. The subject information database DB 213 is stored with the image information stored in the image database DB 211 and the subject information associated with the subject stored in the subject database DB 212. As illustrated in FIG. 4C, the subject information database DB 213 has an “Index” field, a “image ID” field, a “subject ID” field, a “subject area” field and an “already-processed” field.

The identifying information for uniquely identifying the subject information stored in the subject information database DB 213 is stored in the “Index” field. The identifying information for specifying the image information stored in the image database DB 211 is stored in the “image ID” field. The identifying information stored in the “image ID” field is the identifying information stored in the “file Index” field of the image database DB 211. The identifying information specifying the subject stored in the subject database DB 212 is stored in the “subject ID” field. The identifying information stored in the “subject ID” field is the identifying information stored in the “subject ID” field of the subject database DB 212. Area information of an area of the subject's face with its image being captured in the image information specified by the identifying information stored in the “image ID” field, is stored in the “subject area” field. The area information processed by, e.g., the face recognition technology is stored as the area information of the subject's face.

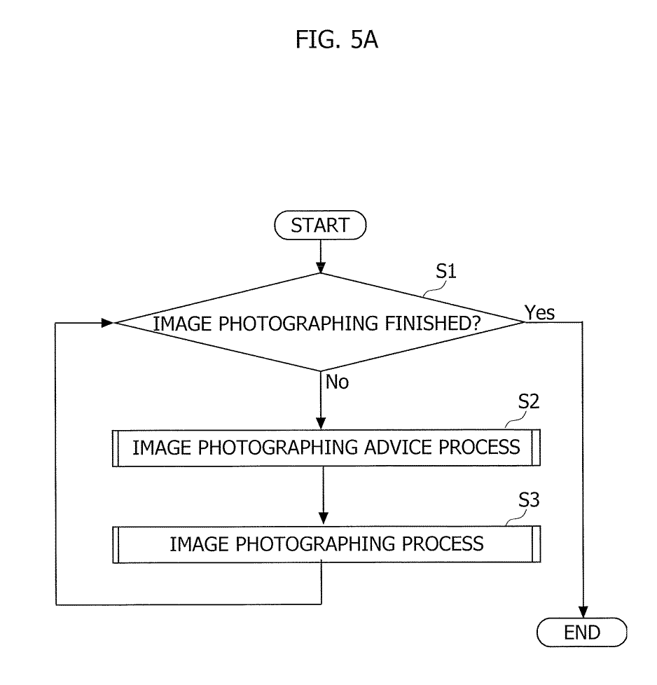

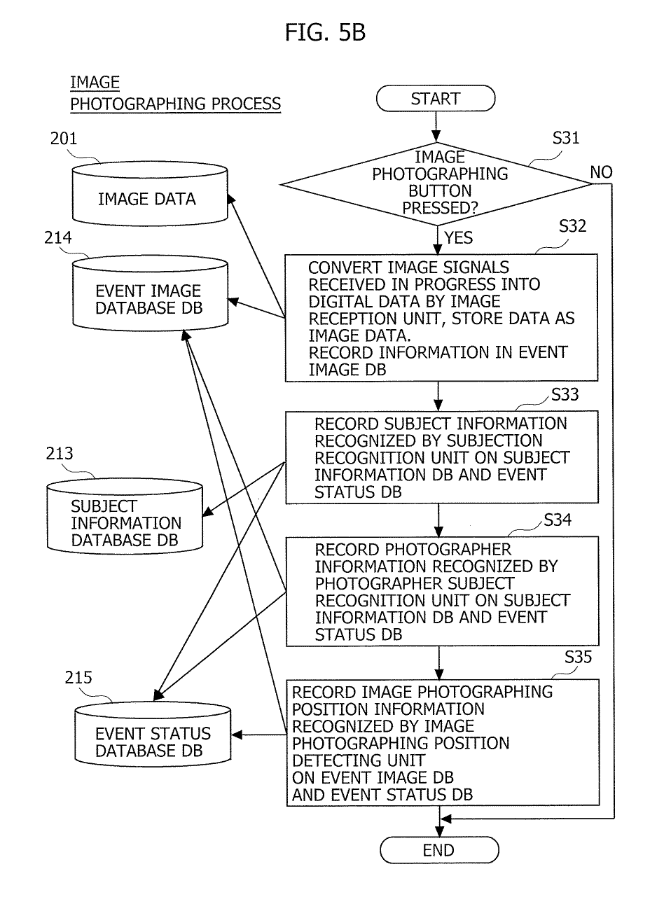

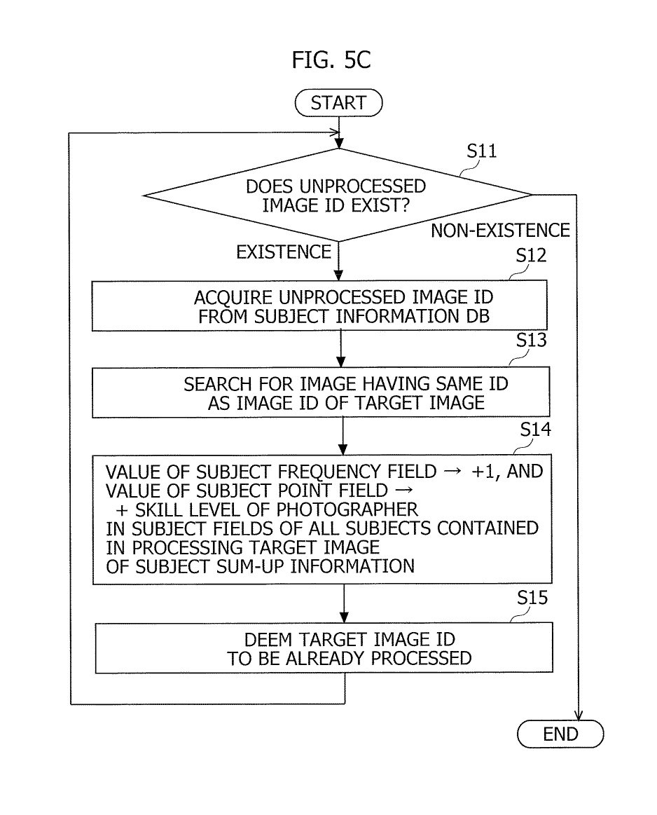

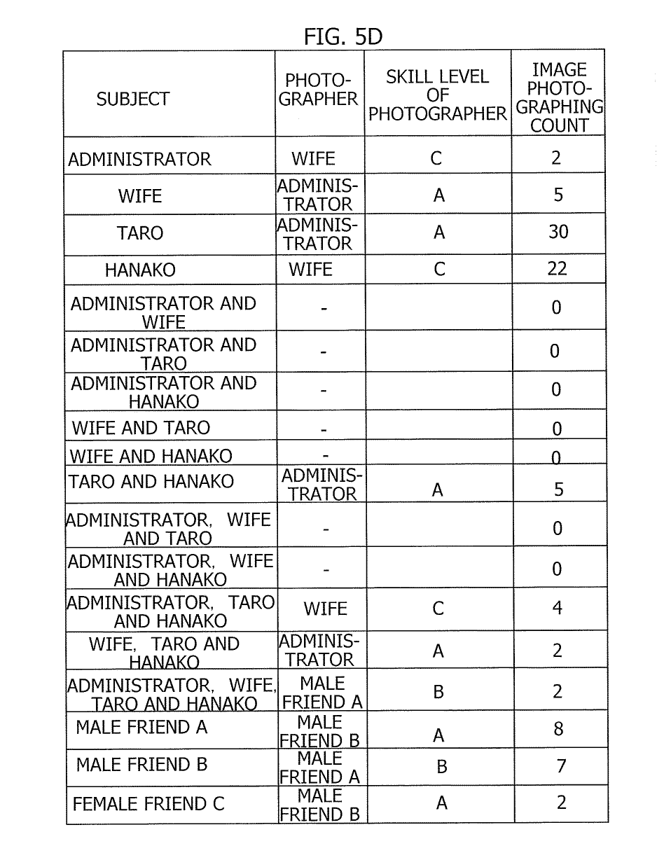

Information about whether a subject sum-up process is completed is stored in the “already-processed” field. The subject sum-up process will be described in detail in FIG. 5C. Note that the information about whether the subject sum-up process is completed can be exemplified by binary status information expressed by 1 bit. For example, the binary status information can be exemplified such that a value “1” is given as one status when the subject sum-up process is completed, while a value “0” is given as another status when the subject sum-up process is not yet completed. Incidentally, it may be sufficient that any information from which the completed status and the uncompleted status of the subject sum-up process are distinguishable from each other is stored as the information to be stored in the “already-processed” field. For example, when the subject sum-up process is not yet completed, a null value may be entered as the status in the “already-processed” field, and characters or a character string like “ZZZ” may also be entered therein.

FIG. 4D illustrates an explanatory diagram of the subject areas contained in the image information. The explanatory diagram illustrated in FIG. 4D depicts the image information specified by pieces of identifying information, i.e., image IDs “1201” entered in association with the “file Index” field of the image database DB 211. The image information depicted in FIG. 4D contains static images captured based on an Half-Video Graphics Array (HVGA) standard in which a pixel count is given by 480 (crosswise)×320 (longitudinal). The image example in FIG. 4D contains a plurality of subject images identified by “1”, “2”, “4” entered in the “subject ID” field of the subject database DB 212.

An image area of the subject's face processed by the face recognition technology and specified by “1” entered in the “subject ID” field is an area A1 covered by a rectangular area of a broken line. An image area of the subject's face specified by “4” entered in the “subject ID” field is an area A2 covered by the rectangular area of the broken line, and an image area of the subject's face specified by “2” entered in the “subject ID” field is an area A3 covered by the rectangular area of the broken line.

The area information stored in the “subject area” field of the subject information database DB 213 can be expressed as the rectangular area defined by, e.g., “(coordinate of left upward corner)-(coordinate of right downward corner)” of the captured face image of the target subject, in which the pixel counts of the image information are grasped as coordinate information. In the image example of FIG. 4D, for instance, the static image containing the plurality of subject images can be expressed in an area size defined by a coordinate (0, 0) of a left upward corner and a coordinate (319, 479) of a right downward corner. Therefore, e.g., the rectangular area covering each of captured subject's faces contained in the static image can be expressed by coordinate values within the area range defined by (0, 0)-(319, 479). The pixel count of the captured image information is grasped as the coordinate information, thereby enabling the area of the captured subject's face region to be specified within the image information.

Referring back to the example of the subject information database DB 213 in FIG. 4C, the area information “(13, 0)-(157, 220)” is entered in the “subject area” field of a record specified by “223” entered in the “Index” field. The record specified by “223” entered in the “Index” field indicates that the face region of the subject specified by “subject ID=1” exists in the rectangular area defined by “(13, 0)-(157, 220) within the static image specified by “image ID=1201”. The image example in FIG. 4D indicates that the area A1 covering the captured face region specified by “subject ID=1” exists in the rectangular area defined by the coordinate (13, 0) of the left upward corner and the coordinate (157, 220) of the right downward corner.

Similarly, the record specified by “224” entered in the “Index” field indicates that the face region of the subject specified by “subject ID=2” exists in the rectangular area defined by “(311, 38)-(458, 232) within the static image specified by “image ID=1201”. Further, the record specified by “225” entered in the “Index” field indicates that the face region of the subject specified by “subject ID=4” exists in the rectangular area defined by “(181, 12)-(289, 159) within the static image specified by “image ID=1201”.

It is to be noted that the subject area information is expressed in such a format that the pixel count of the captured image information is grasped as the coordinate information, and the rectangular area of the captured face image of the target subject is defined by (coordinate of left upward corner)-(coordinate of right downward corner) in the examples of FIGS. 4C-4D, and the format is, however, arbitrary if enabling the face region to be specified. For example, in the subject area information, the face region of the target subject on the image may also be specified in a format of designating the coordinate of the left upward corner of the rectangular area and defining the rectangular area by (crosswise size×longitudinal size). For example, in the example of FIG. 4D, the face region of the subject specified by “subject ID=2” can be expressed as the subject area information such as “(311, 38)-(147×194)”.

The event status database DB 215 contains a subject sum-up information table 215a, an photographer table 215b and an image photographing place table 215c. The subject sum-up information table 215a is stored with accumulation information recorded as the subjects in the image information of the image database DB 211 per participant participating in the event having the image photographing opportunity. The photographer table 215b is stored with photographer information associated with the participant participating in the event in the photographers registered in the photographer information database DB 216. The image photographing place table 215c is stored with the positional information of the image photographing place for the image information captured at the event.

FIG. 4E illustrates one example of the subject sum-up information table 215a. As illustrated in FIG. 4E, the subject sum-up information table 215a has a “subject ID” field, a “subject name” field, a “subject frequency” field and a “subject point” field. The “subject ID” field and the “subject name” field have been described in FIG. 4B and other equivalent drawings. An image photographing frequency of the image, captured as the subject, of the image information accumulated and collected in the image database DB 211, is stored in the “subject frequency” field. A point value taken account of the image photographing status of the image captured as the subject is stored in the “subject point” field. Note that an in-depth descriptions of the “subject frequency” field and the “subject point” field of the subject sum-up information table 215a will be made in FIG. 5C.

FIG. 4F illustrates one example of the photographer information database DB 216. The photographer information database DB 216 is stored with the photographer information about the image information collected and accumulated in the image database DB 211. As illustrated in FIG. 4F, the photographer information database DB 216 has a “photographer ID” field, a “photographer name” field and a “skill level” field. The photographer identifying information for uniquely identifying the photographer is stored in the “photographer ID” field. A name and other equivalent namings of the photographer are stored in the photographer name” field. Note that the information stored in the “photographer name” field may also be namings instanced by pen names from which the photographer and other equivalent persons of the image information stored in the image database DB 211 are distinguishable. For example, in the example of FIG. 4F, in a record specified by “11” entered in the “photographer ID” field, the naming such as “male friend A” is entered in the “photographer name” field.

A rank indicating the image photographing performance level of the photographer who photographs the photo and the video, is stored in the “skill level” field. The image photographing performance level can be expressed by relative ranks at a plurality of stages such as a “rank A (senior level)”, a “rank B (intermediate level)” and a “rank C (beginner level)”. The rank representing the image photographing performance level can be calculated relatively from, e.g., the image photographing numerical quantity of the imaging apparatus 10. This is because a level of skill for the image photographing opportunity is presumed to be high in the case of a large image photographing numerical quantity. For example, a using period of the imaging apparatus 10 can be reflected in the rank representing the image photographing performance level. In the case of a long using period of the imaging apparatus 10, this is presumably because of an abundance of knowledge about an apparatus technique of the imaging apparatus 10, a usage method of the imaging apparatus 10, an image photographing composition of the image, a stop, a shutter speed, a selection of lenses and other equivalent elements. Evaluations given from other persons about the image information of the videos-photos opened in the public by the photographer on an Social Networking Service (SNS) via the network N may be reflected in the ranks representing the image photographing performance levels. For example, the rank representing the image photographing performance level can be relatively calculated based on an evaluation count given by pressing a “like” button for the image information opened in the public.

The rank representing the image photographing performance level, which is stored in the “skill level” field of the photographer information database DB 216 can be calculated as follows on the basis of, e.g., the image photographing numerical quantity, the using period and the evaluations given by other persons described above. Incidentally, it is preferable that a determination target of the image photographing numerical quantity and the using period of the photographer is set to the image information collected and accumulated in, e.g., the image database DB 211. This is because the image photographing performance level of the photographer can be quantitatively evaluated based on the image information recorded in the image database DB 211.

[Evaluation Value 1]

In Evaluation Value 1, evaluation values sorted, e.g., at a plurality of stages per predetermined numerical quantity are given corresponding to the image photographing numerical quantity of the images captured past by the photographer. Herein, the predetermined numerical quantity can be exemplified by a numerical quantity such as 100 photos in the case of the static images and 100 videos in the case of the moving images. The static images and the moving images are mixed, in which case it may be sufficient that the evaluation values are sorted by using a total numerical quantity of the two types of images added together. A sorting example of the plurality of stages can be exemplified by sorting at 10 stages. The sorting at 10 stages enables values of a range of “1” through “10” to be given as the values of Evaluation Value 1.

For example, “1” can be given as the value of Evaluation Value 1 when the image photographing numerical quantity is smaller than “100”, and “2” can be given when equal to or larger than “100” but smaller than “200”. Similarly, according to the values of Evaluation Value 1, the value given as Evaluation Value 1 is increased on a 100-basis each time the image photographing numerical quantity is incremented, and “10” as a highest value of Evaluation Value 1 can be given when the image photographing numerical quantity is equal to or larger than “900”.

[Evaluation Value 2]

In Evaluation Value 2, the evaluation values sorted at the plurality of stages are given corresponding to, e.g., a period during which the image information is captured by the photographer. Herein, the period during which the image information is captured by the photographer is a period ranging from the oldest image photographing date/time to the latest image photographing date/time of the photographer's image information collected and accumulated in the image database DB 211. The sorting example of the plurality of stages can be exemplified by sorting at 5 stages. The sorting at 5 stages enables values of a range of “1” through “5” to be given as the values of Evaluation Value 2.

For example, “1” can be given as the value of Evaluation Value 2 when the image information captured range period is smaller than “one month”, and “2” can be given when equal to or longer than “one month” but shorter than “one year”. Similarly, according to the values of Evaluation Value 2, the value given as Evaluation Value 2 is increased each time the image information captured range period exceeds one year, and “5” as the highest value of Evaluation Value 2 can be given when the image information captured range period is equal to or longer than “3 years”.

[Evaluation Value 3]

In Evaluation Value 3, the evaluation values sorted at the plurality of stages are given corresponding to, e.g., a ratio of the evaluation count of other persons with respect to the image information captured by the photographer to a number of publication chances published to other persons. Herein, the evaluation count can be set as, e.g., a numerical quantity of positive evaluations such as pressing the “like” button with respect to the image information opened in the public via the SNS and other equivalent services. A positive evaluation and a negative evaluation can be selected, in which case the publication chance with a positive evaluation count exceeding a negative evaluation count can be counted as the positive evaluation. The publication chance with the positive evaluation being made for the opened image information may also be counted as the positive evaluation. One single publication chance contains plural sets of image information, in which case when there is a large ratio of the image information with the negative evaluation being made, the publication chance may be counted as the positive evaluation. The example of the sorting at the plurality of stages can be exemplified by the sorting at 3 stages. The sorting at the 3 stages enables the values of a range of “1” through “3” to be given as the values of Evaluation Value 3.

For example, according to the values of Evaluation Value 3, let N be a value obtained by dividing a number of the publication chances with the positive evaluation being acquired by a total number of the publication chances, in which “1” can be given when N<0.3, “2” can be given when 0.3 N<0.7, and “3” can be given when 0.7 N.

[Calculation of Skill Level]

A total evaluation value is calculated based on Evaluation Values 1-3 described above by a Mathematical Expression (1) given below, thereby determining the rank representing the image photographing performance level of the photographer, which is stored in the “skill level” field of the photographer information database DB 216.

Total Evaluation Value=(Value of Evaluation Value 1)×(Value of Evaluation Value 2)×(Value of Evaluation Value 3) Mathematical Expression (1)

For example, when the total evaluation value calculated by Mathematical Expression (1) is equal to or larger than “100”, the rank “A” representing the image photographing performance level is given. Similarly, when the total evaluation value calculated by Mathematical Expression (1) is within a range of being smaller than “100” but equal to or larger than “50”, the rank “B” representing the image photographing performance level is given. When the total evaluation value is smaller than “50”, the rank “C” representing the image photographing performance level is given.

In the example of FIG. 4F, in the records specified by “1” and “12” entered in the “photographer ID” field, the rank “A” is entered in the “skill level” field. In the record specified by “11” entered in the “photographer ID” field, the rank “B” is entered in the “skill level” field. In the records specified by “2” and “13” entered in the “photographer ID” field, the rank “C” is entered in the “skill level” field.

In the example of FIG. 4F, it is recognized that the photographers associated with “1” and “12” entered in the “photographer ID” field are higher in image photographing performance level than the photographers associated with “2”, “11” and “13” entered in the “photographer ID” field. It is also recognized that the photographer associated with “11” entered in the “photographer ID” field is higher in image photographing performance level than the photographers associated with “2” and “13” entered in the “photographer ID” field.

Note that a rate of the image information with an image photographing failure caused due to a hand shake and other equivalent factors in the image information captured past may also be included as an evaluation target for the rank representing the image photographing performance level. Product information instanced by a type of a lens used for the image photographing opportunity may also be included as the evaluation target.

[Processing Flow]

An image photographing assist process of the image photographing assist system 1 according to the embodiment will hereinafter be described with reference to drawings in FIGS. 5A-5D and FIGS. 6A-6M. In the image photographing assist system 1, e.g., the information processing apparatus 11 detects the image photographing opportunity upon receiving the image information in the process of being captured, which is transmitted from the imaging apparatus 10 of the user participating in the event and other equivalents. The information processing apparatus 11 gives the advice to the imaging apparatus 10 by specifying other photographers exhibiting the higher image photographing performance levels and being located in a predetermined range of the imaging apparatus 10, and requesting one of specified other photographers to perform the image photographing suited to the image photographing status. The advice given to the imaging apparatus 10 is displayed by way of, e.g., an advice message on the monitor and other equivalent displays of the imaging apparatus 10. The user of the imaging apparatus 10 can acquire a well-performed result of the image photographing by requesting another photographer exhibiting the higher image photographing performance level and being located in the predetermined range in accordance with, e.g., the advice message displayed on the monitor and other equivalent displays to perform the image photographing related to the image photographing opportunity in the process of capturing the image.

FIG. 5A illustrates a flowchart of the image photographing assist process related to capturing the image information at the event and other equivalents. In the flowchart illustrated in FIG. 5A, a start of the image photographing process can be exemplified by being triggered when accepting the image information in the process of being captured from the camera and other equivalent equipment of the imaging apparatus 10 in the image photographing opportunity at the event and other equivalents. The image information in the process of being captured, which is accepted by the camera and other equivalent equipment of the imaging apparatus 10 is transmitted to the information processing apparatus 11 connected to the network N in a state of being attached with the attribute information like the Exif information together with the image of the subject.

In the flowchart of FIG. 5A, e.g., the imaging apparatus 10, accepting the image information in the process of being captured, of the image photographing assist system 1 determines whether the image photographing of the subject is finished or not (S1). The imaging apparatus 10 finishes the image photographing assist process related to the image photographing when any operation related to the image photographing is not conducted for a fixed period of time or longer in the state of accepting the image information in the process of being captured (S1, Yes). Herein, the operation related to the image photographing is an operation for capturing the image information such as setting the image photographing mode, the stop, the shutter speed and focusing about the image in the process of capturing the image. The imaging apparatus 10 of the image photographing assist system 1 finishes the image photographing assist process when any operation related to the image photographing is not detected for a seconds-based period instanced by 30 seconds and a minutes-based period instanced by 1 minute in the state of accepting the image information of the subject.

Whereas when the operation related to the image photographing is conducted for the fixed period of time in the state of accepting the image information of the subject (S1, No), the imaging apparatus 10 of the image photographing assist system 1 executes the image photographing assist process in S2-S3 related to the image photographing. The image photographing assist system 1 executes an image photographing advice process on the basis of the image information in the process of being captured, which is accepted by the imaging apparatus 10 (S2), and executes an image photographing process by recording the image information in the process of being captured as image data (S3).

An in-depth description of the image photographing advice process in the process of S2 illustrated in FIG. 5A will be made with reference to a flowchart depicted in FIG. 6A, while the image photographing process in the process of S3 will be described in detail with reference to a flowchart depicted in FIG. 5B.

Note that the image photographing assist system 1 according to the embodiment is disabled from giving any advice related to the image photographing because of non-existence of the subject about which the advice is given in the case of, e.g., a scene image and other equivalent images not containing the subject in the image information accepted by the imaging apparatus 10. Therefore, the image photographing assist process illustrated in FIG. 5A may be finished in the case of, e.g., the scene image and other equivalent images not containing the subject in the image information accepted by the imaging apparatus 10.

[Image photographing Process]

The image photographing process of S3 illustrated in FIG. 5A will be described with reference to the flowchart depicted in FIG. 5B. In the image photographing process illustrated in FIG. 5B, the imaging apparatus 10 of the image photographing assist system 1 determines the pieces of image information in the process of being captured at the event and other equivalents upon a trigger of operating the image photographing button like the shutter button. The determined pieces of image information are stored respectively in the image database DB 201, the event image database DB 214 and the event status database DB 215 of the auxiliary storage unit 93 equipped in the imaging apparatus 10.

In the flowchart illustrated in FIG. 5B, the imaging apparatus 10 of the image photographing assist system 1 detects, e.g., an event of pressing the image photographing button like the shutter button (S31). The imaging apparatus 10 of the image photographing assist system 1 finishes the image photographing process illustrated in FIG. 5B when not detecting the event of pressing the image photographing button like the shutter button (S31, No). Whereas when detecting the event of pressing the image photographing button like the shutter button (S31, Yes), the imaging apparatus 10 of the image photographing assist system 1 executes the processes in S32-S35 and finishes the image photographing process.

In the process of S32, the imaging apparatus 10 converts image signals received in progress, which are accepted by the image reception unit 101, into digital data, and stores (records) the digital data as image information in the image database DB 201 of the auxiliary storage unit 93. The imaging apparatus 10 further stores (records), e.g., reference information of the image information, the attached information instanced by the Exif information and other equivalent information, which are stored in the auxiliary storage unit 93, in the event image database DB 214 via the network N. Note that the reference information of the image information corresponds to the items of information stored in the “file name” field, the “storage location” field and other equivalent fields of the image database DB 211 illustrated in FIG. 4A. The Exif information and other equivalent information as the attached information of the image information correspond to the items of information stored in the “image photographing date/time” field, the image photographing place” field and other equivalent fields of the image database DB 211 illustrated in, e.g., FIG. 4A.

In the process of S33, e.g., the imaging apparatus 10 stores the information of the subject contained in the image information, which is recognized by the subject recognition unit 111, in the event status database DB 215. In the process of S33, the imaging apparatus 10 stores the information of the subject recognized by the subject recognition unit 111 in the “subject ID” field and the “subject name” field of the subject sum-up information table 215a of the event status database DB 215 illustrated in, e.g., FIG. 4E. Note that when the target image information contains the plurality of subjects, the imaging apparatus 10 stores a plurality of subject IDs connected by a comma “,” in the “subject ID” field.

In the process of S33, the information processing apparatus 11 of the image photographing assist system 1 also stores, in the subject information database DB 213, the subject information contained in the image information, which is recognized by the subject recognition unit 111, along with storing the subject information in the subject sum-up information table 215a.

For example, the information processing apparatus 11 detects an event that the imaging apparatus 10 writes the subject information in the subject sum-up information table 215a via an Application Programming Interface (API) and other equivalent interfaces. The information processing apparatus 11 may simply store the information of the subject specified by the subject recognition unit 111 in the “subject ID” field and the “subject area” field of the subject information database DB 213 illustrated in, e.g., FIG. 4C upon being triggered by writing the subject information detected via the API. The subject information is stored in the subject information database DB 213 on a subject-by-subject basis. The information processing apparatus 11 attaches the image identifying information (image ID) for uniquely identifying the image to the target image information, and stores the information of the subject specified by the subject recognition unit 111. The image identifying information attached by the information processing apparatus 11 is stored in, e.g., the “image ID” field of the subject information database DB 213.

In the process of S34, e.g., the imaging apparatus 10 stores the information of the photographer specified by the photographer recognition unit 112 in the event image database DB 214 and the event status database DB 215. In the process of S34, for instance, the imaging apparatus 10 stores the information of the photographer specified by the photographer recognition unit 112 in the “photographer ID” field of the event image database DB 214. In the process of S34, e.g., the imaging apparatus 10 further stores the information of the photographer specified by the photographer recognition unit 112 in the photographer table 215b of the event status database DB 215.

In the process of S35, e.g., the imaging apparatus 10 stores the image photographing positional information related to the image photographing opportunity of the image information, which is detected by the image photographing position detecting unit 103, in the event image database DB 214 and the event status database DB 215. In the process of S35, for instance, the imaging apparatus 10 stores the image photographing positional information related to the image photographing opportunity, which is detected by the image photographing position detecting unit 103, in the “image photographing place” field of the event image database DB 214. In the process of S35, e.g., the imaging apparatus 10 further stores the image photographing positional information related to the image photographing opportunity, which is detected by the image photographing position detecting unit 103, in the image photographing place table 215c of the event status database DB 215. Note that the imaging apparatus 10 extracts the image photographing positional information related to the image photographing opportunity from the attached information instanced by the Exif information attached to the image information, and stores the extracted attached information in the event image database DB 214 in the process of S32, in which case the imaging apparatus 10 may skip over the process of S35 with respect to the event image database DB 214.

In the flowchart illustrated in FIG. 5B, in the processes of S33-S34, the subject information and the photographer information of the image information are stored in the event image database DB 214 and the event status database DB 215, and thereafter the imaging apparatus 10 executes the subject sum-up process depicted in FIG. 5C.

(Subject Sum-Up Process)

FIG. 5C illustrates a flowchart of the subject sum-up process for the image information captured by the imaging apparatus 10. The information processing apparatus 11 of the image photographing assist system 1 according to the embodiment executes the subject sum-up process illustrated in FIG. 5C, thereby enabling a calculation of the subject frequency occurring in the image information acquired by image photographing the subject with respect to the image information captured by the imaging apparatus 10. The information processing apparatus 11 of the image photographing assist system 1 can calculate the subject point, about the image photographing status, of the subject that is photographed by way of the image information of the subject by the subject sum-up process illustrated in FIG. 5C. Herein, the subject point is, e.g., a point value weighted by the image photographing performance level (skill level) of the photographer that photographs the subject with respect to the subject appearing in the image information. For example, the values stored in the “subject frequency” field and the “subject point” field of the subject sum-up information table 215a illustrated in FIG. 4E, are updated by the subject sum-up process depicted in FIG. 5C.

FIG. 5D illustrates an explanatory diagram of the image photographing status in which the subject is photographed at the event and other equivalents. In the explanatory diagram illustrated in FIG. 5D, information stored in a “subject” field represents the event participant appearing as the subject in the image information, and information stored in a “photographer” field represents the event participant who captures the image information. In the explanatory diagram of FIG. 5D, the information stored in a “skill level of photographer” field represents the image photographing performance level of the event participant who captures the image information, and information stored in a “image photographing count” field represents a numerical quantity of the captured image information. In the example of the explanatory diagram of FIG. 5D, the event participants are seven persons, i.e., an “administrator”, a “wife”, “Taro”, “Hanako”, a “male friend A”, a “male friend B”, and a “female friend C”. Relationships between the event participants are such that the “administrator” and the “wife” are in their matrimony, and “administrator” and the “wife” are in parenthood of “Taro” and “Hanako”. The “male friend A”, the “male friend B”, and the “female friend C” are the friends common to the “administrator” and the “wife”. The “administrator” and the “male fried B” have a skill level “A” indicating the image photographing performance level, the “male fried A” has the skill level “B”, and the “wife” and the “female friend C” have a skill level “C”.

In the explanatory example of FIG. 5D, the numerical quantity of the image information is “2” in such a case that the “wife” photographs only the “administrator” as the subject. The numerical quantity of the image information is “5” in such a case that the “administrator” photographs only the “wife” as the subject. “Taro” and the “administrator” behave together, and hence the numerical quantity of the image information is “30” in such a case that the “administrator” photographs only “Taro” as the subject. “Hanako” and the “wife” behave together, and hence the numerical quantity of the image information is “22” in such a case that the “wife” photographs only “Hanako” as the subject. The “male friend A” and the “male friend B” behave together, and therefore the numerical quantity of the image information is “7” in such a case that the “male friend B” photographs only the “male friend A” as the subject and is also “7” in such a case that the “male friend A” photographs only the “male friend B” as the subject. The “female fiend C” has a tendency to behave individually for image photographing scenes, flowers and other equivalent objects, and consequently the numerical quantity of the image information is “2” in such a case that the “male friend B” passing nearby photographs only the “female friend C” as the subject.

The “administrator” has a role of image photographing a combination of “Taro” and “Hanako”, and hence the numerical quantity of the image information is “5” in such a case that the “administrator” photographs “Taro” and “Hanako” as the subjects. The numerical quantity of the image information is “4” in such a case that the “wife” photographs three persons, i.e., the “administrator”, “Taro” and “Hanako”. The numerical quantity of the image information is “2” in such a case that the “administrator” photographs three persons, i.e., the “wife”, “Taro” and “Hanako”. The numerical quantity of the image information is “2” in such a case that the “male fried A”, who is asked to capture their images, photographs four persons, i.e., the “administrator”, the “wife”, “Taro” and “Hanako”.

The “administrator” and the “wife” as the married couple have no such opportunity that the couple is photographed together after births of their children, and are habitually photographed together with their two children in the case of being photographed with their children. Consequently, the numerical quantity of the image information is “0” in combinations, i.e., a combination of the “administrator” and the “wife”, a combination of the “administrator” and “Taro”, a combination of the “administrator” and “Hanako”, a combination of the “wife” and “taro”, a combination of the “wife” and “Hanako”, a combination of the “administrator”, the “wife” and “Taro”, and a combination of the “administrator”, the “wife” and “Hanako”.

The information processing apparatus 11 executes the subject sum-up process illustrated in FIG. 5C with respect to the image information captured in the status depicted in, e.g., FIG. 5D, thereby calculating values to be stored in the “subject frequency” field and the “subject point” field illustrated in FIG. 4E.

In the flowchart illustrated in FIG. 5C, a start of the subject sum-up process can be exemplified by being triggered upon completing the process in S34 illustrated in, e.g., FIG. 5B. The information processing apparatus 11 detects completion of writing the subject information to the subject sum-up information table 215a via the Application Programming Interface (API) and other equivalent interfaces. The information processing apparatus 11 detects the completion of writing the subject information to the subject sum-up information table 215a, and executes the subject sum-up process in S11-S15 with respect to the image information captured at the event.

In the flowchart illustrated in FIG. 5C, the information processing apparatus 11 determines whether there exists any record with the subject sum-up process not being completed by referring to, e.g., the subject information database DB 213 (S11). The information processing apparatus 11 determines whether there exists any record in which information instanced by “0” and “ZZZ” indicating that the subject sum-up process is not yet completed, is stored in the “already-processed” field of the subject information database DB 213. Alternatively, the information processing apparatus 11 determines whether there exists any record in which the “already-processed” field of the subject information database DB 213 is in a null state.

The information processing apparatus 11 finishes the subject sum-up process when there exists neither the record in which the “already-processed” field of the subject information database DB 213 is in the null state nor the record containing the information instanced by “0” indicating that the subject sum-up process is not yet completed (S11, “non-existence”). Whereas when there exist the record in which the “already-processed” field of the subject information database DB 213 is in the null state and the record containing the information instanced by “0” indicating that the subject sum-up process is not yet completed (S11, “existence”), the information processing apparatus 11 executes the processes in S12-S15.

The information processing apparatus 11 acquires the image ID stored in the “image ID” field of the record with the subject sum-up process not being completed in the process of S11 (S12). The information processing apparatus 11 searches for the record containing the same ID information as the image ID acquired in the process of S12 by referring to the subject information database DB 213 (S13).

The information processing apparatus 11 calculates the subject frequency and the subject point with respect to the image ID acquired in the processes of S12-S13 (S14). The subject frequency and the subject point are calculated per image ID. The information processing apparatus 11 specifies the subject ID of the captured subject with respect to the image ID acquired in the processes of, e.g., S12-S13. For example, in the image ID=“1201” illustrated in FIG. 4D, the image information contains three human subjects specified by the subject IDs=“1”, “2” and “4”. The information processing apparatus 11 specifies that the subjects contained in the image ID are three persons having the subject IDs=“1”, “2” and “4” in the image ID acquired in the processes of S12-S13. The information processing apparatus 11 counts the image photographing numerical quantity, by “1”, of the image information having the image ID containing the three captured subjects specified by a set of subject IDs=“1”, “2” and “4” on a 3-tuple basis.

The information processing apparatus 11 searches through the “subject ID” field of the subject sum-up information table 215a, thereby specifying a record containing the set of subject IDs=“1”, “2” and “4”. The information processing apparatus 11 sums up the counted image photographing numerical quantity in the “subject frequency” field of the record containing the subject IDs=“1”, “2” and “4” being stored in the “subject ID” field in the subject sum-up information table 215a. The value “1” is added as the image photographing numerical quantity to the value stored in the “subject frequency” field of the record with the subject IDs=“1”, “2” and “4” being stored in the “subject ID” field in the subject sum-up information table 215a.

The information processing apparatus 11 searches through the event image database DB 214 on the basis of the image ID acquired in the processes of S12-S13, thereby acquiring the photographer ID contained in the record associated with this image ID. The information processing apparatus 11 searches through the photographer information database DB 216 on the basis of the acquired photographer ID, thereby acquiring the skill level contained in the record associated with this photographer ID.

The information processing apparatus 11 adds the subject point to the skill level of the photographer having the acquired photographer ID. The addition of the subject point is determined corresponding to, e.g., the skill level. For example, when the skill levels are sorted at three stages, “A”, “B”, “C”, a point “3” can be weight-added to the skill level “A”, a point “2” can be weight-added to the skill level “B”, and a point “1” can be weight-added to the skill level “C”.

The information processing apparatus 11 sums up the points determined corresponding to the skill levels of the photographers specified by the photographer IDs in the “subject point” field of the record containing the subject IDs=“1”, “2” and “4” being stored in the “subject ID” field in the subject sum-up information table 215a. For example, when the skill level associated with the photographer ID is “A”, a point value “3” is added to the value stored in the “subject point” field of the record with subject IDs=“1”, “2” and “4” being stored in the “subject ID” field in the subject sum-up information table 215a. Similarly, when the skill level associated with the photographer ID is “B”, a point value “2” is added to the “subject point” field of the target record, and when the skill level is “C”, a point value “1” is added to the “subject point” field of the target record.

In the process of S15, the information processing apparatus 11 completes the subject sum-up process with respect to the target image ID in the processes of S12-S14. The information processing apparatus 11 refers to, e.g., the subject information database DB 213, and stores “1” indicating the completion of the subject sum-up process in the “already-processed” field of the record containing the target image ID in the processes of S12-S14. The information processing apparatus 11 repeats the processes of S11-S15, and finishes the subject sum-up process for the image information acquired at the target event. Through the processes of S11-S15, there is completed the process of calculating the subject frequency and the subject point in the subject sum-up information table 215a with respect to the image information acquired at the target event.

The results of the subject sum-up processes for the image information captured in the explanatory example in FIG. 5D, for example, are stored in the “subject frequency” field and the “subject point” field of the respective records of the subject sum-up information table 215a illustrated in FIG. 4E.

For example, in the explanatory example of FIG. 5D, the “wife” having the skill level “C” indicating the image photographing performance level performs image photographing the “administrator” as the subject, in which case the numerical quantity of the image information is “2”. The subject ID of the “administrator” is “1”. As a result of the subject sum-up process illustrated in FIG. 5C, the information processing apparatus 11 sums up, as the “subject frequency”, the numerical quantity of the image information in the case of image photographing only the “administrator”. The information processing apparatus 11 further sums up, as the “subject point”, a value obtained by multiplying the point value of the skill level “C” of the photographer by the numerical quantity of the image information of only the “administrator” who is photographed by the photographer. The “subject frequency” and the “subject point” which are summed up are stored in the subject sum-up information table 215a.

In the subject sum-up information table 215a illustrated in FIG. 4E, in the record specified by the subject ID=“1”, a value “2” is entered as the summed-up numerical quantity of the image information in the “subject frequency” field. A value “2” is entered as the point value corresponding to the summed-up skill level of the photographer in the “subject point” field of the record specified by the subject ID=“1”.

In the explanatory example of FIG. 5D, the “male friend A” having the skill level “B” indicating the image photographing performance level performs image photographing four persons, i.e., the “administrator”, the “wife”, “Taro” and “Hanako” as the subjects, in which case the numerical quantity of the image information is “2”. The subject ID of the “administrator” is “1”, the subject ID of the “wife” is “2”, the subject ID of the “Taro” is “3”, and the subject ID of the “Hanako” is “4”.

In the subject sum-up process, the information processing apparatus 11 sums up, as the “subject frequency”, the numerical quantities of the image information obtained by image photographing the four persons, i.e., the “administrator”, the “wife”, “Taro” and “Hanako”. The information processing apparatus 11 further sums up, as the “subject point”, a value obtained by multiplying the point value of the photographer having the skill level “B” by a total numerical quantity of the image information obtained when the photographer performs image photographing the four persons, i.e., the “administrator”, the “wife”, “Taro” and “Hanako”. In the record specified by the subject ID=“1, 2, 3, 4” of the subject sum-up information table 215a illustrated in FIG. 4E, the value “2” as the summed-up numerical quantity of the image information is entered in the “subject frequency” field. Further, “4” as the summed-up point value corresponding to the skill level of the photographer is entered in the “subject point” field of the record specified by the subject ID=“1, 2, 3, 4”.

[Image photographing Advice Process]

The image photographing advice process in S2 illustrated in FIG. 5A will be described with reference to a flowchart depicted in FIG. 6A. In the information processing apparatus 11 according to the embodiment, the image photographing advice process involves executing processes related to the image photographing advice process for each of the information processing apparatus 11 and the imaging apparatus 10. In the image photographing advice process illustrated in FIG. 6A, the information processing apparatus 11 determines the image photographing status at the event and other equivalents on the basis of the image information in the process of being captured, which is transmitted from the imaging apparatus 10, and transmits the changeability information of the photographer corresponding to the image photographing status to the imaging apparatus 10. For example, the imaging apparatus 10 receives the changeability information, transmitted from the information processing apparatus 11, of the photographer, and displays the image photographing advice corresponding to the changeability information on the display device for the monitor. The image photographing advice information corresponding to the image photographing status at the event and other equivalents is displayed to the photographer via the display device for the monitor of the imaging apparatus 10.

In the flowchart illustrated in FIG. 6A, a process in S21 will be described in detail in FIGS. 6B-6D. A process in S23 will be described in detail in FIG. 6E. A process in S25 will be described in detail in FIGS. 6E-6H. A process in S26 will be described in detail in FIGS. 6I-6M.

In the flowchart illustrated in FIG. 6A, a start of the image photographing advice process can be exemplified by being triggered when the information processing apparatus 11 receives the image information in the process of being captured, which is transmitted via the network N from the imaging apparatus 10. The information processing apparatus 11 of the image photographing assist system 1 executes, e.g., the subject recognition process about the received image information in the process of being captured, thereby recognizing the subject contained in the image information (S21).

The information processing apparatus 11 recognizes, e.g., the user (photographer) of the imaging apparatus 10 transmitting the image information in the process of being captured (S22). The information processing apparatus 11 acquires, e.g., address information related to the communications of the imaging apparatus 10, and associates the acquired address information with the user of the imaging apparatus 10, thus specifying the photographer of the received image information.

In the flowchart illustrated in FIG. 6A, the imaging apparatus 10 of the image photographing assist system 1 detects other imaging apparatuses located in the proximity distance range with respect to this imaging apparatus 10 (S23). The imaging apparatus 10 further detects, e.g., the positional information of other imaging apparatuses 10 in the process of capturing the image information (S24).

For example, the imaging apparatus 10 detects the latitude/longitude information as the positional information of other imaging apparatuses 10 by causing the GPS function to function. The imaging apparatus 10 temporarily stores the information of other imaging apparatuses and the image photographing positional information thereof, which are detected in the processes of S22-S23, in a predetermined area of the main storage unit 92. The imaging apparatus 10 then transmits the information of other imaging apparatuses and the image photographing positional information thereof, which are detected in the processes of S22-S23, to the information processing apparatus 11 connected to the network N. Note that the information processing apparatus 11 may execute the processes in S21-S22 in parallel with executing the processes in S23-S24 by the imaging apparatus 10.

In the process in S25, the information processing apparatus 11 determines the image photographing status related to the image information in the process of being captured on the basis of, e.g., the subject information and the photographer information, which are recognized in the processes of S21-S22, and the information of other imaging apparatuses and the image photographing positional information thereof, which are transmitted from the imaging apparatus 10. The information processing apparatus 11 generates the changeability information of the photographer with respect to the image information in the process of being captured, corresponding to the determined image photographing status, and transmits the generated changeability information to the imaging apparatus 10.

In the process of S26, the imaging apparatus 10 specifies the image photographing advice information corresponding to the image photographing status at the event and other equivalents, based on the changeability information of the photographer with respect to the image information in the process of being captured, which is transmitted from the information processing apparatus 11. The imaging apparatus 10 refers to, e.g., the image photographing advice database DB 217, and thus specifies the image photographing advice information about the image information in the process of being captured, corresponding to the changeability information of the photographer with respect to the image information in the process of being captured, which is transmitted from the information processing apparatus 11.

The image photographing advice information specified in the process of S26 is displayed on, e.g., the display device for the monitor such as the EL panel of the output unit 95 equipped in the imaging apparatus 10. The imaging apparatus 10 causes the image photographing advice information to be displayed by being superposed on, e.g., the image information in the process of being captured. The image photographing advice information specified in the process of S26 is displayed to the user via the display device for the monitor of the imaging apparatus 10.

In the image photographing assist system 1 according to the embodiment, the image photographing process illustrated in FIG. 5A is executed after finishing the image photographing advice process illustrated in FIG. 6A, and the image photographing assist system 1 is thereby enabled to display the image photographing advice information corresponding to the image photographing status to the photographer in the process of capturing the image information via the imaging apparatus 10. The image photographing advice information can be displayed on the monitor and other equivalent displays of the imaging apparatus 10 by being superposed on the image information in the process of being captured. The user (photographer) of the imaging apparatus 10 can recognize the image photographing advice information displayed on the monitor and other equivalent displays before determining the process of capturing the image information in the process of being captured. The user of the imaging apparatus 10 can request, e.g., other photographers exhibiting the higher image photographing performance levels and being located in the proximity distance range of the imaging apparatus 10 to perform the image photographing in accordance with the image photographing advice information. As a result, the user of the imaging apparatus 10 of the image photographing assist system 1 according to the embodiment can enhance the possibility of acquiring the well-performed result of the image photographing. The image photographing assist system 1 according to the embodiment can provide the technology of enhancing the possibility of obtaining the well-performed result of the image photographing at the event and other equivalents.

Herein, the processes of S23-S24 executed by the information processing apparatus 11 are given as one example of “second managing positional information of an apparatus associated with each of the individual”. The CPU 91 and other equivalent units of the information processing apparatus 11 execute the processes of S23-S24 as one example of “second managing positional information of an apparatus associated with each of the individual”.

[Subject Recognition Process]

The process in S21 illustrated in FIG. 6A will be described with reference to a flowchart depicted in FIG. 6B. In the image photographing assist system 1 according to the embodiment, the process in S21 is executed as a subject recognition process in the information processing apparatus 11. The information processing apparatus 11 executes a flowchart of the subject recognition process illustrated in FIG. 6B on the basis of the image information in the process of being captured, which is transmitted from the imaging apparatus 10.

In the flowchart of FIG. 6B, the information processing apparatus 11 executes a face detection process for the image information in the process of being captured, which is received from, e.g., the imaging apparatus 10 (S41), and then executes a face recognition process (S42). The face detection process in S41 will be described in detail in FIG. 6C. The face recognition process in S42 will be described in detail in FIG. 6D.

The information processing apparatus 11 extracts unprocessed face information from face information of the subject, which is recognized in the processes of S41-S42 (S43). The information processing apparatus 11 determines whether the unprocessed face information exists (S44), and finishes the subject recognition process when the unprocessed face information does not exist (S44, “non-existence”). Whereas when the unprocessed face information exists (S44, “existence”), the information processing apparatus 11 determines whether the face information extracted in the process of S43 is already registered in the subject database DB 212 (S45).

The information processing apparatus 11, when the face information extracted in the process of S43 is already registered in the subject database DB 212 (S45, “already registered”), proceeds to a process in S46. Whereas when the face information extracted in the process of S43 is not yet registered in the subject database DB 212 (S45, “unregistered”), the information processing apparatus 11 proceeds to a process in S47 by skipping the process in S46.

In the process of S46, the information processing apparatus 11 adds a record of the face information extracted in the process of S43 to the subject information database DB 213. For example, the information processing apparatus 11 enters the image ID of the image information containing the face information extracted in the process of S43 in the “image ID” field, and further enters the subject ID identical with the face information in the “subject ID” field. For instance, the information processing apparatus 11 enters the area of the captured subject's face within the image information extracted in the process of S43 in the “subject area” field.

The information processing apparatus 11 proceeds to the process in S47, and iterates the subject recognition process for the received image information in the process of being captured by deeming that the subject recognition process will have been done about the face information extracted in the process of S43. The information processing apparatus 11 repeats, e.g., the processes in S41-S47 till the unprocessed face information does not exist in the received image information in the process of being captured.

(Face Detection Process)

Next, the face detection process in S41 illustrated in FIG. 6B will be described with reference to a flowchart depicted in FIG. 6C. The face detection process illustrated in FIG. 6C is executed based on pattern matching with template data representing the facial features instanced by eyes, a nose and a mouth. The information processing apparatus 11 executes the face detection process based on a degree (matching degree) of the pattern matching between the target image information and the template data.

In the flowchart illustrated in FIG. 6C, the information processing apparatus 11 extracts an unprocessed reception image as a target of the face detection process with respect to the image information in the process of being captured, which is received from the imaging apparatus 10 (S51). The information processing apparatus 11 determines whether there exists the reception image becoming, e.g., a target of the face detection process (S52), and finishes the face detection process when such a reception image does not exist (S52, “non-existence”). Whereas when there exists the reception image becoming the target of the face detection process (S52, “existence”), the information processing apparatus 11 executes processes in S53-S59 for the reception image extract in the process of S51.

In the process of S53, e.g., the information processing apparatus 11 refers to the template data stored in the auxiliary storage unit 93 and other equivalent storages, and thus obtains a minimum size of data from within the template data of the eyes, the nose and the mouth that feature the face. The template data contain plural sizes of data. The obtained minimum size of template data is temporarily stored in, e.g., the predetermined area of the main storage unit 92.

In the process of S54, the information processing apparatus 11 performs pattern-matching-based scanning by using the template data acquired in the process of S53 in a way that targets on the reception image extracted in the process of S51, and thus calculates the matching degree. The information processing apparatus 11 calculates the matching degree while shifting a pattern matching target area on the reception image in a right-and-left direction. The information processing apparatus 11, when the pattern matching target area reaches any one of end portions in the right-and-left direction on the reception image, shifts a position of the target area used for calculating the matching degree in an up-and-down direction, and again performs scanning the reception image by repeating the calculation of the matching degree in the right-and-left direction. The calculated matching degree with the template data is temporarily stored in, e.g., the predetermined area of the main storage unit 92 together with area information containing a coordinate of the target area.

In the process of S55, the information processing apparatus 11 compares the matching degree calculated in the process of S53 with, e.g., a threshold value for determining that the target area is a face area, and thus determines whether the area with the matching degree exceeding the threshold value exists. The information processing apparatus 11 proceeds to the process in S56 when the area with the matching degree exceeding the threshold value exists (S55, “existence”). Whereas when the area with the matching degree exceeding the threshold value does not exist (S55, “non-existence”), the information processing apparatus 11 diverts to the process in S57 by skipping the process in S56.

In the process of S56, the information processing apparatus 11 temporarily stores the target area, as the face area information, with the matching degree exceeding the threshold value in the process of S53 in the predetermined area of the main storage unit 92. The information processing apparatus 11, e.g., when the target area with the matching degree exceeding the threshold value is superposed on other target areas with the matching degrees exceeding the threshold values, stores the target area exhibiting the highest matching degree as the face area information. Whereas when the target area with the matching degree exceeding the threshold value is not superposed on other target areas with the matching degrees exceeding the threshold values, the information processing apparatus 11 stores the target area as the face area information.

In the process of S57, the information processing apparatus 11 refers to, e.g., the template data stored in the auxiliary storage unit 93 and other equivalent storages, and thus acquires the template data having a size higher by one level than the size of template data obtained in the process of S53. The information processing apparatus 11 temporarily stores the acquired template data in, e.g., the predetermined area of the main storage unit 92.

In the process of S58, the information processing apparatus 11 determines whether the size of the template data acquired in the process of S57 is equal to or larger than, e.g., a maximum size. The information processing apparatus 11 loops back to S54 and repeats the processes in S54-S58 when the size of the template data acquired in the process of S57 is smaller than the maximum size (S58, No).

Whereas when the size of the template data acquired in the process of S57 is equal to or larger than the maximum size (S58, Yes), the information processing apparatus 11 deems that the reception image extracted in S51 is already processed (S59), and iterates the processes in S51-S59 by looping back to S51. The information processing apparatus 11 iterates the processes in S51-S59 till the unprocessed face area information does not exist in the received image information in the process of being captured.

(Face Recognition Process)

Next, the face recognition process in S42 illustrated in FIG. 6B will be described with reference to a flowchart illustrated in FIG. 6D. The face recognition process illustrated in FIG. 6D is executed based on a degree of similarity between the face area information detected in the process of S61 in FIG. 6B and the face area information of the subject which is registered in the subject information database DB 213.

In the flowchart illustrated in FIG. 6D, the information processing apparatus 11 extracts, e.g., the unprocessed face area information as a target of the face recognition process from the face area information detected in the process of S41 in FIG. 6B (S61). The information processing apparatus 11 determines, e.g., whether there exists the face area information as the target of the face recognition process (S62), and finishes the face recognition process when the face area information as the target of the face recognition process does not exist (S62, “non-existence”). Whereas when the unprocessed face area information as the target of the face recognition process exists (S62, “existence”), the information processing apparatus 11 executes processes in S63-S6a with respect to the face area information extracted in the process of S61.

In the process of S63, for example, the information processing apparatus 11 acquires facial feature parameters within the face region with respect to the face area information extracted in the process of S61. Herein, the feature parameters represent what positions of the eyes, the nose and the mouth within the area surrounded by an outline of the face are parameterized as vector data. The information processing apparatus 11 temporarily stores the acquired feature parameters in, e.g., the predetermined area of the main storage unit 92.

In the process of S64, for instance, the information processing apparatus 11 refers to the subject database DB 212 and the subject information database DB 213, and thus acquiring the facial feature parameters of the subject not yet undergoing the face recognition process. The information processing apparatus 11 temporarily stores the feature parameters, which are acquired by referring to the subject database DB 212 and the subject information database DB 213, in the predetermined area of the main storage unit 92 by being associated with the subject ID.

The information processing apparatus 11 determines whether the subject not yet undergoing the face recognition process exists in, e.g., subject database DB 212 and other equivalent databases (S65), and proceeds to a process in S69 when the subject not yet undergoing the face recognition process does not exist (S65, “non-existence”). Whereas when the subject not yet undergoing the face recognition process exists in the subject database DB 212 and other equivalent databases (S65, “existence”), the information processing apparatus 11 proceeds to the process in S66.

In the process of S66, the information processing apparatus 11 calculates, e.g., the degree of similarity between the feature parameters acquired in the process of S63 and the feature parameters acquired in the process of S64. Herein, the degree of similarity can be obtained from a difference between the feature parameters acquired in the process of S63 and the feature parameters acquired in the process of S64. For example, the degree of similarity can be obtained from such a calculation that the degree of similarity is set to “1” when a distance value is “0”, the distance value being acquired from a difference between two sets of vector data, as the two sets of feature parameters, of the positions of the eyes, the nose and the mouth within face region.

The information processing apparatus 11 determines a magnitude relationship with a threshold value by comparing the calculated degree of similarity between the two sets of feature parameters with the threshold value for determining the degree of similarity. The information processing apparatus 11 proceeds to the process in S67 when the degree of similarity between the two sets of feature parameters is equal to or larger than the threshold value (S66, “larger”). Whereas when the calculated degree of similarity between the two sets of feature parameters is smaller than the threshold value (S66, “smaller”), e.g., the information processing apparatus 11 proceeds to a process in S68 by skipping the process in S67.

In the process of S67, the information processing apparatus 11 records, as person candidate data, the face area information extracted in the process of S61, the subject ID acquired in the process of S64 and the degree of similarity calculated in the process of S66 with respect to the subject about which the degree of similarity calculated in the process of S66 is equal to or larger than the threshold value. The information processing apparatus 11 temporarily stores the person candidate data in, e.g., the predetermined area of the main storage unit 92.

In the process of S68, e.g., the information processing apparatus 11 deems that the face recognition process about the subject ID acquired in the process of S64 is already done (S68), then loops back to the process of S64, and repeats the processes in S64-S68. The information processing apparatus 11 repeats the processes in S64-S68 till the unprocessed face area information does not exist in, e.g., the subject database DB 212.

In the process of S69, e.g., the information processing apparatus 11 generates a face information list as a face recognition result of the subject having the face area information extracted in the process of S61 by referring to the person candidate data stored in the process of S67, and temporarily stores the generated list in the predetermined area of the main storage unit 92. The face information list contains, e.g., the face area information extracted in the process of S61, and the subject ID acquired in the process of S64. Note that the information processing apparatus 11, e.g., when the person candidate data are not generated in the process of S67, registers the non-existence of the target subject in the face information list in the face recognition process. When a single set of the person candidate data is provided, the information processing apparatus 11 stores the generated person candidate data in the face information list. For example, the information processing apparatus 11 stores, as the face information list, the information of the subject exhibiting the highest degree of similarity when plural sets of the person candidate data exist.

In the process of S6a, e.g., the information processing apparatus 11 deems that the face recognition process about the face area information extracted in the process of S61 is already done, then loops back to the process of S61, and repeats the processes in S61-S6a. The information processing apparatus 11 repeats the processes in S61-S6a till the unprocessed face area information does not exist in, e.g., the face area information detected in the face detection process.

(Proximity Status Detection Process)

Next, a proximity status detection process in S23 illustrated in FIG. 6A will be described with reference to a flowchart depicted in FIG. 6E. The proximity status detection process illustrated in FIG. 6E is executed based on the positional information of the imaging apparatuses 10, which is acquired by, e.g., the GPS function and other equivalent functions.

In the flowchart illustrated in FIG. 6E, the imaging apparatus 10, for instance, acquires the positional information by causing the GPS function to function while capturing the image information of the subject (S71), and transmits the acquired positional information to the information processing apparatus 11 (S72). The information processing apparatus 11 transmits, to the imaging apparatus 10, a list stored with the positional information acquired from other imaging apparatuses 10 connected to the image photographing assist system 1. The positional information can be expressed as coordinate information instanced by the latitude, the longitude and the altitude. The list contains, e.g., the photographer IDs and the photographer names which are associated with other imaging apparatuses. The imaging apparatus 10 acquires the list transmitted by the information processing apparatus 11 via the network N (S73).

The imaging apparatus 10 calculates, e.g., distance values between the imaging apparatus 10 and other imaging apparatuses, based on the positional information of other imaging apparatuses registered in the list acquired in the process of S73 (S74). The imaging apparatus 10 compares each of the calculated distance values with the threshold value for determining the magnitude relationship with these distance values, and generates an imaging apparatus list (proximity apparatus list) structured so that other imaging apparatuses with the distance values being equal to or smaller than the threshold value are arranged in the sequence from the smallest of the distance values (S74). The imaging apparatus 10 temporarily stores the generated imaging apparatus list in, e.g., the predetermined area of the main storage unit 92.

Note that the imaging apparatus list generated by the imaging apparatus 10 in the process of S73 may also be generated by the information processing apparatus 11 acquiring, e.g., the positional information of the imaging apparatus 10. The information processing apparatus 11 generates the imaging apparatus list by calculating the distance values based on the positional information of other imaging apparatuses connected to the image photographing assist system 1 via the network N and the positional information of which the imaging apparatus 10 notifies. The information processing apparatus 11 may simply transmit the generated imaging apparatus list to the imaging apparatus 10.

(Image Photographing Status Determination Process)

Next, an image photographing status determination process in S25 illustrated in FIG. 6A will be described with reference to a flowchart depicted in FIG. 6F. The image photographing status determination process illustrated in FIG. 6F is executed by the information processing apparatus 11 of the image photographing assist system 1. The image photographing status determination process illustrated in FIG. 6E involves determining the image photographing status in the process of the image being captured at the event and other equivalents on the basis of processing results in S21-S24 illustrated in FIG. 6A, and generating the changeability information of the photographer, corresponding to the image photographing status. The information processing apparatus 11 transmits, via the network N, notification of completing generation of the changeability information of the photographer corresponding to the image photographing status, which is generated in the image photographing status determination process, to the imaging apparatus 10 that is image photographing the subject in progress.

In the flowchart illustrated in FIG. 6F, in a process of S81, the information processing apparatus 11 acquires the subject information contained in the image information in the process of being captured, which is recognized in the subject recognition process in S21 illustrated in FIG. 6A, and the information of the photographer in the process of capturing the image information recognized in the process of S22. The information processing apparatus 11 acquires the list of other imaging apparatuses located in the proximity distance range of the imaging apparatus 10, which are detected in the process of S23 illustrated in FIG. 6A, and the positional information of the imaging apparatus 10, which is detected in the process of S24. The information processing apparatus 11 generates the image photographing status information based on the various items of acquired information. The generated image photographing status information is temporarily stored in, e.g., the predetermined area of the main storage unit 92.

FIG. 6G illustrates an example of an image photographing status information list. The image photographing status information list illustrated in FIG. 6G has, e.g., a “photographer” field, a “subject” field, a “image photographing position” field and a “proximity terminal information” field. An photographer ID of the photographer in the process of capturing the image information recognized in the process of S22, is stored in the “photographer” field. A subject ID of the subject contained in the image information in the process of being captured, which is recognized in the process of S21, is stored in the “subject” field. Positional information of the imaging apparatus 10 in the process of capturing the image, which is detected in S24, is stored in the“image photographing position” field. The photographer IDs of the photographers associated with other imaging apparatuses located in the proximity distance range of the imaging apparatus 10 in the process of capturing the image, which detected in S23, are stored in the“proximity terminal information” field.

In the example of FIG. 6G, in a record specified by “ID=1” entered in the“photographer” field, a plurality of subject IDs such as “ID=2, ID=3, ID=4” is entered in the “subject” field. In addition to the latitude/longitude information such as “north latitude x1” and “east longitude y1”, an item of information such as “bearing z1” acquired by causing, e.g., the electronic compass function to function is entered in the “image photographing position” field of the same record. A plurality of photographer IDs such as “ID=11, ID=12, ID=13” is entered in the “proximity terminal information” field. The information processing apparatus 11 generates the image photographing status information list illustrated in FIG. 6G in a process of S81.

Referring back to the flowchart illustrated in FIG. 6F, in a process of S82, the information processing apparatus 11 refers to, e.g., the photographer information database DB 216, and thus acquires the photographer information of the photographers registered in the image photographing status information list generated in the process of S81. For example, the information processing apparatus 11 acquires, from the photographer information database DB 216, the photographer information specified by the photographer IDs stored in the “photographer” field of the image photographing status information list. For instance, the information processing apparatus 11 acquires, from the photographer information database DB 216, the photographer information specified by the photographer IDs stored in the “proximity terminal information” field of the image photographing status information list. The information processing apparatus 11 temporarily stores the photographer information specified by the photographer IDs acquired from the photographer information database DB 216 in, e.g., the predetermined area of the main storage unit 92.

In a process of S83, for example, the information processing apparatus 11 searches the event status database DB 215 for the items of information stored in the “subject” field, the “photographer” field and the “image photographing position” field contained in the image photographing status information list generated in the process of S81. The information processing apparatus 11 searches for, e.g., the subject sum-up information tables 215a of the event status database DB 215 by using the photographer IDs as a search key stored in the “photographer” field, and the image photographing place tables 215c of the event status database DB 215 by using the latitudes/longitudes as the search key stored in the “image photographing position” field.

The information processing apparatus 11 specifies the subject sum-up information table 215a associated with the respective information in the “photographer” field and the “image photographing position” field. The information processing apparatus 11 acquires, from the specified subject sum-up information table 215a, such items of information representing the past image photographing statuses as the subject frequency and the subject point each associated with the subject ID by searching through this table 215a with the subject ID as the search key stored in the “subject” field of the image photographing status information list. The information processing apparatus 11 temporarily stores such items of information representing the past image photographing statuses as the subject frequency and the subject point each associated with the subject ID, which are acquired from the subject sum-up information table 215a, in, e.g., the predetermined area of the main storage unit 92.

In a process of S84, the information processing apparatus 11 determined a possibility of changing the image photographing status in the process of capturing the image on the basis of the photographer information and such items of information representing the past image photographing statuses as the subject frequency and the subject point each associated with the subject ID, these items of information being acquired in the processes of, e.g., S82-S83. The information processing apparatus 11 generates, e.g., a changeability list 218 illustrated in FIG. 6H as a result of determining the possibility of changing the image photographing status in the process of capturing the image. The changeability list 218 is a list stored with point information and other equivalent information for determining superiority or inferiority about the possibility and the changeability in the case of changing the subject and the photographer with respect to the image photographing status in the process of capturing the image. The information processing apparatus 11 temporarily stores the generated changeability list 218 in, e.g., the predetermined area of the main storage unit 92.

FIG. 6H illustrates one example of the changeability list 218 generated in the process of S84. The changeability list 218 illustrated in FIG. 6H has, e.g., a “list ID” field, a “photographer” field, a “photographer change flag” field, a “subject” field, a “subject change flag” field, a “image photographing position” field, a “image photographing position change flag” field and a “point” field.

Identifying information (list ID) for uniquely identifying the post-changing image photographing status is stored in the “list ID” field. Note that a record specified by “1” entered in the “list ID” field contains various items of information representing the image photographing status in the process of capturing the image. The photographer ID in the process of capturing the image and the post-changing photographer ID are stored in the “photographer” field. Note that the post-changing photographer IDs are the photographer IDs related to, e.g., other imaging apparatuses stored in the “proximity terminal information” field of the image photographing status information list generated in the process of S82.

Flag information indicating whether the photographer in the process of capturing the image information is changed or not, is stored in the “photographer change flag” field. Information indicating binary statuses such as “0” and “1” can be exemplified as the flag information stored in the “photographer change flag” field. For example, the flag information which is set to “0” when the photographer is not changed and is set to “1” when the photographer is changed, can be stored in the “photographer change flag” field.

The subject ID is stored in the “subject” field. Note that the subject ID stored in the “subject” field contains a subject ID associated with, e.g., the photographer ID. Flag information indicating whether the subject contained in the image information in the process of being captured is changed, is stored in the “subject change flag” field. The flag information which indicates the binary statuses to be set to “0” when the subject is not changed and to “1” when the subject is changed, is stored in the “subject change flag” field.

The positional information and other equivalent information of the image photographing place in the process of capturing the image are stored in the “image photographing position” field. Note that the positional information and other equivalent information stored in the“image photographing position” field may contain, e.g., image photographing bearing information indicating an image photographing direction, which is acquired by the electronic compass function. The image photographing bearing information can be expressed by a relative angle in a range of 0-360 degrees, in which the relative angle to the true north is set to “0 degree” clockwise. Flag information indicating whether the image photographing place in the process of capturing the image is changed, is stored in the “image photographing position change flag” field. The flag information which indicates the binary statuses to be set to “0” when the image photographing place in the process of capturing the image is not changed and to “1” when the image photographing place in the process of capturing the image is changed, is stored in the“image photographing position change flag” field.

A point value calculated from a difference between the image photographing status in the process of capturing the image and a changeable status, is stored in the “point” field. The point value stored in the “point” field is calculated by the following Mathematical Expression (2).

Point Value=(Point Given Due to Change of Photographer)+(Point Given Due to Change of Subject) Mathematical Expression (2).

(Point Given Due to Change of Photographer) in the Mathematical Expression (2) is calculated based on, e.g., the “skill levels” as index values indicating the image photographing performance levels of the photographer in the process of capturing the image and another changeable photographer. The information processing apparatus 11 compares the skill level of the photographer in the process of capturing the image with the skill level of another changeable photographer, based on the “skill levels” of the photographer information acquired from, e.g., the photographer information database DB 216 in the process of S82. The information processing apparatus 11 may simply calculate the point value corresponding to, e.g., the skill levels of the photographer in the process of capturing the image and another changeable photographer.

For example, when the photographer in the process of capturing the image and another changeable photographer have the same skill level, the point value can be exemplified by being set to “0”. To give another example, the skill level of another changeable photographer is higher than the skill level of the photographer in the process of capturing the image, in which case the point value can be exemplified by giving “+1” whenever higher by one stage. Similarly, the skill level of another changeable photographer is lower than the skill level of the photographer in the process of capturing the image, in which case the point value can be exemplified by giving “−1” whenever lower by one stage.

For example, the “skill level” of the photographer in the process of capturing the image is “C”, and the “skill level” of another changeable photographer is “A”, in which case a point value “+2” is given as (Point Given Due to Change of Photographer) in the Mathematical Expression (2). While on the other hand, the “skill level” of the photographer in the process of capturing the image is “A”, and the “skill level” of another changeable photographer is “C”, in which case a point value “−2” is given as (Point Given Due to Change of Photographer).

(Point Given Due to Change of Subject) in the Mathematical Expression (2) is calculated from the point value stored in the “subject point” field of the subject sum-up information table 215a of the event status database DB 215.

The information processing apparatus 11 acquires a value stored in the “subject point” field of the record containing the changeable subject by referring to the subject sum-up information table 215a. The information processing apparatus 11 calculates a difference between the value stored in the “subject point” field of the record containing the subject in the process of its image being captured and the value stored in the “subject point” field of the record containing the changeable subject, which are acquired in the process of, e.g., S83. For example, the information processing apparatus 11 sets the difference value calculated from the values stored in the “subject point” fields as the point value of (Point Given Due to Change of Subject) in the Mathematical Expression (2). This is because the point value in the “subject point” field of the subject sum-up information table 215a is incremented corresponding to the image photographing numerical quantity.

For instance, in the subject sum-up information table 215a illustrated in FIG. 4E, “6” is a value stored in the “subject point” field of the record specified by “ID=2, 3, 4” entered in the “subject ID” field. In the case of assuming the subjects specified by “ID=1, 2, 3, 4” as the changeable subjects, “4” is a value stored in the “subject point” field of the record specified by “ID=1, 2, 3, 4” entered in the “subject ID” field of the subject sum-up information table 215a. With respect to the changeability from “ID=2, 3, 4” to “ID=1, 2, 3, 4” of the subjects in the process of capturing the image, the information processing apparatus 11 sets “2” calculated from the difference between the values stored in the “subject point” fields as the point value of (Point Given Due to Change of Subject).

The information processing apparatus 11 stores a point value in the “point” field of the changeability list 218, the point value being calculated by adding the points, i.e., (Point Given Due to Change of Photographer)+(Point Given Due to Change of Subject).

In the example of the changeability list 218, a record specified by “1” entered in the “list ID” field contains “0”, “0” and “0” that are entered in the “photographer change flag” field, the “subject change flag” field and the “image photographing position change flag” field in order to store the image photographing status in the process of capturing the image. Similarly, this same record contains “0” entered in the “point” field. Note that the same information as in the image photographing status information list generated in the process of, e.g., S81 and illustrated in FIG. 6G is stored in the “photographer” field, the “subject” field and the “image photographing position” field of the record specified by “1” entered in the “list ID” field.

In the example of the changeability list 218 in FIG. 6H, there are generated records for indicating the changeability of the image photographing status for the photographers specified by “ID=11”, “ID=12”, “ID=13” entered in the “proximity terminal information” field of the image photographing status information list illustrated in FIG. 6G. In the example of FIG. 6H, the record for indicating the changeability of the image photographing status for the photographer specified by “ID=11” is a record specified by “2” entered in the “list ID” field. Similarly, the record for indicating the changeability of the image photographing status for the photographer specified by “ID=12” is a record specified by “3” entered in the “list ID” field, and the record for indicating the changeability of the image photographing status for the photographer specified by “ID=13” is a record specified by “4” entered in the “list ID” field. In these records, “1”, “1”, “1” for indicating the change of the photographer are entered in the “photographer change flag” field.

In the example of FIG. 6H, “ID=1, ID=2, ID=3, ID=4” for indicating the subject IDs of the photographers in the process of capturing the image is entered in the “subject” field of each of the records with the photographer being changed. Further, “1”, “1”, “1” for indicating the change of the subject are entered in the “subject change flag” field of each of the records with the photographer being changed. Note that the positional information of the image photographing place in the process of capturing the image is stored in the “image photographing position” field of each of the records with the photographer being changed, and “0”, “0”, “0” are entered in the “image photographing position change flag” field thereof because of no change from the image photographing place in the process of capturing the image.

As illustrated in FIG. 6H, for instance, the information processing apparatus 11 can determine that the subject in the process of its image being captured is a family member of the photographer, and may simply, in this case, prioritize the changeability of the subject so that the photographer and the subject in the process of its image being captured can be simultaneously photographed. A relationship between the subject in the process of its image being captured and the photographer can be specified from, e.g., the image information captured in the past image photographing statuses and the information when registering the photographers in the image photographing assist system 1. The information processing apparatus 11 adopts the prioritization of the changeability of the subject, and is thereby enabled to generate the changeability list taking account of, e.g., the relationships of the participants participating the event.

The change of the photographer for the image information in the process of the image being captured is also assumed so that the subject in the process of the image being captured becomes the photographer, and, however, the changeability of the photographer may be prioritized to make a change to another photographer located in the proximity distance range. This is because, when the image being captured contains the plurality of subjects, it is feasible to determine it to be a more preferable image photographing status to capture the image with the photographer being added as the subject than capturing the image with part of the subjects being removed.

Referring back to the explanatory diagram of the example of the changeability list 218 illustrated in FIG. 6H, “1” is entered in the “point” field of the record specified by “ID=11” entered in the “photographer” field. Further, “2” is entered in the “point” field of the record specified by “ID=12” entered in the “photographer” field, and “0” is entered in the “point” field of the record specified by “ID=13” entered in the “photographer” field.

For example, in the photographer information database DB 216 illustrated in FIG. 4F, the “skill level” associated with the photographer ID=1 is “A”; the “skill level” associated with the photographer ID=11 is “B”; the “skill level” associated with the photographer ID=12 is “A”; and the “skill level” associated with the photographer ID=13 is “C”. For example, in the subject sum-up information table 215a illustrated in FIG. 4E, a value “6” is entered in the “subject point” field of the record specified by “ID=2, 3, 4” entered in the “subject ID” field. A value “4” is entered in the “subject point” field of the record specified by “ID=1, 2, 3, 4” entered in the “subject ID” field.

For example, the information processing apparatus 11 calculates the point value of (Point Given Due to Change of Photographer) in the Mathematical Expression (2) as “−1” from the “skill level” associated with the photographer ID=1 and the “skill level” associated with the photographer ID=11. The information processing apparatus 11 also calculates the point value of (Point Given Due to Change of Subject) in the Mathematical Expression (2) as “2” from the “subject points” of the subjects specified by “ID=2, 3, 4” and the subjects specified by “ID=1, 2, 3, 4”. The information processing apparatus 11 enters “1” in the “point” field of the record specified by “ID=11” entered in the “photographer” field on the basis of the Mathematical Expression (2).

Similarly, the information processing apparatus 11 calculates the point value of (Point Given Due to Change of Photographer) as “0” from the “skill level” associated with the photographer ID=1 and the “skill level” associated with the photographer ID=12. The information processing apparatus 11 also calculates the point value of (Point Given Due to Change of Subject) as “2” from the “subject points” of the subjects specified by “ID=2, 3, 4” and the subjects specified by “ID=1, 2, 3, 4”. The information processing apparatus 11 enters “2” in the “point” field of the record specified by “ID=12” entered in the “photographer” field on the basis of the Mathematical Expression (2).

The information processing apparatus 11 further calculates the point value of (Point Given Due to Change of Photographer) in the Mathematical Expression (2) as “−2” from the “skill level” associated with the photographer ID=1 and the “skill level” associated with the photographer ID=13. The information processing apparatus 11 also calculates the point value of (Point Given Due to Change of Subject) in the Mathematical Expression (2) as “2” from the “subject points” of the subjects specified by “ID=2, 3, 4” and the subjects specified by “ID=1, 2, 3, 4”. The information processing apparatus 11 enters “3” in the “point” field of the record specified by “ID=13” entered in the “photographer” field on the basis of the Mathematical Expression (2).

In the process of S84 in the flowchart illustrated in FIG. 6F, the information processing apparatus 11 generates the foregoing changeability list 218 in which the changeabilities of changing the photographer, the subject and the image photographing position are expressed as the point values. The generated changeability list 218 is temporarily stored in, e.g., the predetermined area of the main storage unit 92. The information processing apparatus 11 transmits, to the imaging apparatus 10 in the process of capturing the image, the notification of completing the generation of the changeability information of the photographer corresponding to the image photographing status as triggered by storing the generated changeability list 218 in the auxiliary storage unit 93.

Herein, the processes of S81-S83 executed by the information processing apparatus 11 are one example of “generating, based on the image photographing skill on the individual basis and the positional information in response to an assist request given from an imaging apparatus, assist information containing existence information of an image photographing enabled person within a predetermined range from the imaging apparatus”. The CPU 91 and other equivalent units of the information processing apparatus 11 execute the processes of S81-S83 by way of one example of “generating, based on the image photographing skill on the individual basis and the positional information in response to an assist request given from an imaging apparatus, assist information containing existence information of an image photographing enabled person within a predetermined range from the imaging apparatus”.

(Image Photographing Advice Notifying Process)

Next, an image photographing advice notifying process in S26 illustrated in FIG. 6A will be described with reference to a flowchart illustrated in FIG. 6I. For example, the imaging apparatus 10 of the image photographing assist system 1 executes the image photographing advice notifying process illustrated in FIG. 6I. In the image photographing advice notifying process illustrated in FIG. 6I, e.g., the imaging apparatus 10 specifies the image photographing advice information corresponding to the image photographing status in the process of capturing the image on the basis of the notification of completing the generation of the changeability list 218 generates as a result of the process in S25 illustrated in FIG. 6A. The imaging apparatus 10 displays the specified image photographing advice information by being superposed on, e.g., the image information in the process of the image being captured, which is displayed on the monitor screen of the EL panel and other equivalent displays.

In the flowchart illustrated in FIG. 6I, in a process of S91, the imaging apparatus 10 acquires, e.g., a set value of an advice display count to be displayed on the EL panel and other equivalent displays as triggered by receiving the completion notification from the information processing apparatus 11. The imaging apparatus 10 refers to, e.g., the changeability list 218 stored in the auxiliary storage unit 93 of the information processing apparatus 11, and thus acquires, as a display target advice, the records corresponding to the set value of the advice display count acquired from the advice display count setting table 202. The imaging apparatus 10 obtains the records corresponding to the set value of the advice display count acquired from the advice display count setting table 202 in the sequence from, e.g., the highest of the point values stored in the “point” field of the changeability list 218. The imaging apparatus 10 temporarily stores the obtained records of the changeability list 218 in, e.g., the predetermined area of the main storage unit 92.

FIG. 6J illustrates one example of the advice display count setting table 202. The advice display count setting table 202 has a “set item” field stored with a set item such as the display count, a “default value” field stored with a numerical value, i.e., the default value of the advice display count, and a “present value” field stored with a numerical value, i.e., the present value of the advice display count. The numerical value, which is preset by the imaging apparatus 10, is stored in the “default value” field of the advice display count setting table 202, and the numerical value, which is set by the photographer and other equivalent persons of the imaging apparatus 10, is stored in the “present value” field. In the example of FIG. 6J, “1” is entered in the “default value” field, and “2” is entered in the “present value” field.

In a process of S91 depicted in FIG. 6I, e.g., the imaging apparatus 10 refers to the advice display count setting table 202 illustrated in FIG. 6J, and thus acquires “2” entered as the display count in the “present value” field of the record specified by the “advice display count” entered in the “set item” field.

The imaging apparatus 10 refers to the point values stored in the “point” field of the changeability list 218 illustrated in, e.g., FIG. 6H, and thus acquires, as the display target advice, the records corresponding to the numerical quantity of the advice display count in the sequence from the highest of the point values. In the example of FIG. 6H, the point value associated with the photographer ID=12 is “2”, and the point value associated with the photographer ID=11 is “1”. The imaging apparatus 10 acquires, from, e.g., the changeability list 218, the record containing “2” entered in the “point” field and the record containing “1” entered in the “point” field as the display target advice, and temporarily stores these records in, e.g., the predetermined area of the main storage unit 92.

The records acquired by the imaging apparatus 10 as the display target advice in the process of S91 illustrated in FIG. 6I, are illustrated in FIG. 6K. As illustrated in FIG. 6K, the records acquired by the imaging apparatus 10 from the changeability list 218 are stored in the predetermined area of the main storage unit 92 in the sequence from, e.g., the highest of the point values.

The record specified by “3” entered in the “list ID” field in FIG. 6K exhibits such a changeability of the image photographing status as to change the subject in the process of the image being captured to include the subject ID=1, 2, 3, 4 and to change the photographer to another photographer specified by the photographer ID=12. The record specified by “2” entered in the “list ID” field exhibits such a changeability of the image photographing status as to change the subject in the process of the image being captured to include the subject ID=1, 2, 3, 4 and to change the photographer to another photographer specified by the photographer ID=11. The imaging apparatus 10 displays the advice for the changeability of the image photographing status in the process of capturing the image along with, e.g., the records of the changeability list 218 illustrated in FIG. 6K.

In the flowchart illustrated in FIG. 6I, in the process of S92, the imaging apparatus 10 refers to, e.g., the image photographing advice database DB 217, and thus acquires a character string of an advice content matching with the records serving as the display target advice obtained in the process of S91.

FIG. 6L illustrates one example of the image photographing advice database DB 217. The image photographing advice database DB 217 has, e.g., an “advice ID” field, a “change content” field, and an “advice character string” field. Identifying information (advice ID) for uniquely identifying the advice is stored in the “advice ID” field. Change target attribute information for changing the image photographing status is stored in the “change content” field. The change target attribute information contains, e.g., the photographer, the subject, the image photographing place and other equivalent items. The change target attribute information corresponds to, e.g., the change target attribute information containing “1” entered in the “photographer change flag” field, the “subject change flag” field and the “image photographing position change flag” field of the changeability list 218. Character string information of the display target advice is stored in the “advice character string” field. The advice character string information contains, e.g., an insertion area into which the change target attribute information is inserted as the character string and other equivalent forms. The insertion area for the advice character string information is defined by, e.g., a tag set “< >” for indicating this insertion area.

In the example of FIG. 6L, for instance, the “photographer” becoming the change target determined from the image photographing status in the process of capturing the image is entered in the “change content” field of a record specified by “1” entered in the “advice ID” field. Such a message for prompting the user to change the photographer as “a person having <photographer ID> is nearby you. Ask this person to photograph an image, will you?”, is entered in the “advice character string” field of the same record.

For example, “the photographer and the subject” becoming the change targets changed from the image photographing status in the process of capturing the image are entered in the “change content” field of a record specified by “11” entered in the “advice ID” field. A message for prompting the user to include the photographer in the process of capturing the image as a subject after changing the photographer, such as “a person having <photographer ID> is nearby you. Ask this person to photograph an image including you, will you?”, is entered as an advice character string in the “advice character string” field of the same record.

Note that the “photographer ID” inserted into the insertion area of the advice character string represents the identifying information (the photographer ID) of the “photographer” entered in the “change content” field. The imaging apparatus 10 may simply replace, e.g., after acquiring the advice character string, the character string “the photographer ID” in the insertion area defined by the tag set in the advice character string by text information of the photographer specified by “the photographer ID” entered in the “photographer” field of the record illustrated in FIG. 6K. The imaging apparatus 10 acquires the photographer name entered in the “photographer name” field of the record associated with the photographer ID by referring to, e.g., the photographer information database DB 216 illustrated in FIG. 4F, and may simply replace the character string the “photographer ID” in the advice character string by the acquired photographer name.

In a process of S92 illustrated in FIG. 6I, the imaging apparatus 10 specifies the change target attribute information by referring to the values stored in, e.g., the “photographer change flag” field, the “subject change flag” field and the “image photographing position change flag” field of the records of the changeability list 218 acquired in the process of S91. For example, in exemplified records in FIG. 6K the items of the change target attribute information with the status value “1” being entered in the flags of the “photographer change flag” field, the “subject change flag” field and the “image photographing position change flag” field, are the “photographer” and the “subject”. The imaging apparatus 10 specifies the record containing the “photographer” and the “subject” entered in the “change content” field by referring to the image photographing advice database DB 217, and acquires the advice character string stored in the “advice character string” field of the specified record. The acquired advice character string says “a person having <photographer ID> is nearby you. Ask this person to photograph an image including you, will you?” in the record specified by “11” entered in the “advice ID” field.

The imaging apparatus 10 refers to the photographer information database DB 216, and thus specifies the photographer name stored in the “photographer name” field of the record associated with the photographer ID stored in the “photographer” field in the records of the changeability list 218 acquired in the process of S91. For example, the imaging apparatus 10 specifies that the photographer specified by “ID=12” entered in the “photographer” field is “male friend B” and the photographer specified by “ID=11” is “male friend A” in the records illustrated in FIG. 6K. The imaging apparatus 10 generates, e.g., the advice character string by replacing the character string in the insertion area contained in the advice character string with the specified photographer name. The following are the advice character strings generated corresponding to the records in FIG. 6K:
List ID=3: “the male friend B is nearby you. Ask this person to photograph an image including you, will you?”; and
List ID=2: “the male friend A is nearby you. Ask this person to photograph an image including you, will you?”.

The imaging apparatus 10 temporarily stores the advice character string generated in the process of S92 illustrated in FIG. 6I in, e.g., the predetermined area of the main storage unit 92.

Referring back to the flowchart illustrated in FIG. 6I, in a process of S93, the imaging apparatus 10 specifies a method of displaying the display target advice by referring to, e.g., an advice display method setting table stored in the auxiliary storage unit 93. The advice character string generated in the process of S92 is displayed by the display method specified in the process of S93 (S94). The imaging apparatus 10 displays the advice character string generated in the process of S92 in, e.g., the display area of the monitor instanced by the EL panel by being superposed on the image information in the process of the image being captured.

Herein, the processes of S91-S94 executed by the imaging apparatus 10 are one example of “acquiring, from the information processing apparatus, assist information containing existence information of an image photographing enabled person within a predetermined range from the imaging apparatus, the assist information being generated based on the image photographing skill and the positional information; and outputting the acquired assist information to an output unit”. The CPU 91 and other equivalent units of the imaging apparatus 10 execute the processes of S91-S94 by way of one example of “acquiring, from the information processing apparatus, assist information containing existence information of an image photographing enabled person within a predetermined range from the imaging apparatus, the assist information being generated based on the image photographing skill and the positional information; and outputting the acquired assist information to an output unit”.

FIG. 6M illustrates one example of an advice display method setting table 203. The advice display method setting table 203 illustrated in FIG. 6M contains a plurality of display modes, such as emitting or not emitting effective sounds when displaying the advice character string, of a display method of displaying the advice character string displayed on the monitor instanced by the EL panel and other equivalent displays by being associated with set values.

The advice display method setting table 203 illustrated in FIG. 6M has a “set value” field, a “file name” field and a “description of display method” field. A numerical value indicating the display method is stored in the “set value” field. A name of a file specifying a display format of the advice character string is stored in the “file name” field. The file specifying the display format of the advice character string can be exemplified by a file described in an Extensible Markup Language (XML) format and other equivalent formats. The file specifying the display format of the advice character string contains, e.g., designations about text information instanced by fonts, a display position and a display timing on the EL panel and other equivalent displays, emission or non-emission of the effective sounds when displaying, and a type of the effective sound. The imaging apparatus 10 displays the advice character string in accordance with the file described by the XML, which is stored in the “file name” field. A brief description of the display method designated by the file stored in the “file name” field, is stored in the “description of display method” field.

In the example of FIG. 6M, “1” entered in the “set value” field of the record is a default value of the imaging apparatus 10. The default value indicates the display method of simultaneously displaying the advice character strings related to the plurality of changeabilities in the display area of the EL panel and other equivalent displays, while any effective sounds are not emitted when displaying the advice character string, the display method being assumed to be frequently used by the user.

In the example of FIG. 6M, for example, it is assumed that the record specified by “3” entered in the“set value” field is selected by an operation of the user of the imaging apparatus 10. The display method selected by the user's operation is a display method of sequentially displaying the advice character strings related to the plurality of changeabilities in the display area of the EL panel and other equivalent displays, while the effective sounds are added when displaying the advice character string.

The imaging apparatus 10 specifies the display method of displaying the advice character string by referring to “Advice3.xml” entered in the“file name” field of the record specified by “3” entered in the“set value” field. The imaging apparatus 10 performs displaying, sequentially, the advice character strings related to the plurality of changeabilities in the display area of the EL panel and other equivalent displays, while adding the effective sounds when displaying the advice character strings, the advice character strings being generated in the process of S92 in FIG. 6I. Note that the advice character strings to be displayed in the display area of the EL panel and other equivalent displays, are sequentially displayed in the sequence from, e.g., the highest of the point values of the records illustrated in FIG. 6K.

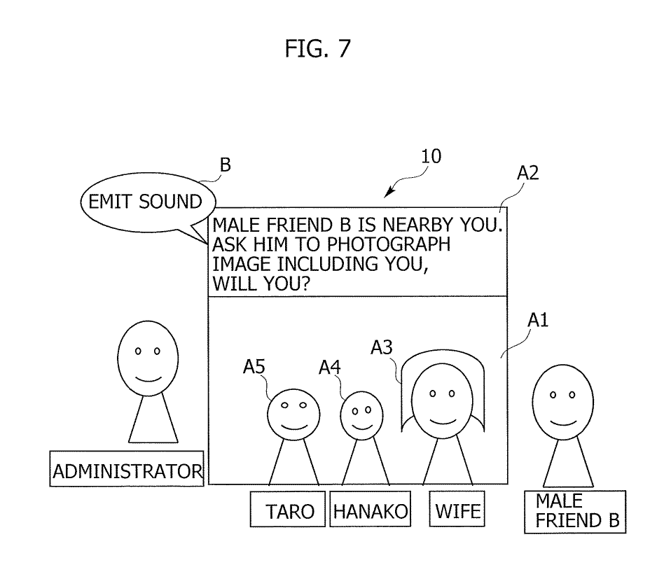

FIG. 7 depicts an explanatory diagram of the display method of the advice character string in the imaging apparatus 10. The display method of the advice character string in FIG. 7 is a display method specified in the process of, e.g., S93 in FIG. 6I. The imaging apparatus 10 displays the advice character string by being superposed on the image information in the process of the image being captured on the monitor instanced by the EL panel and other equivalent displays.

Note that the image photographing status illustrated in FIG. 7 is a status of performing the image photographing, in which, e.g., the photographer, who is the administrator specified by the photographer ID=1, photographs the subjects, i.e., the wife having the subject ID=2, Taro having the subject ID=3 and Hanako having the subject ID=4. The event participants include the male friend B, the unillustrated male friend A, the female friend C. The male friend A, the male friend B and the female friend C have the imaging apparatuses connected to the image photographing assist system 1, and the male friend A and the male friend B are detected as the photographers associated with other imaging apparatuses located in the proximity distance range to the imaging apparatus 10 in the process of capturing the image. The male friend A is the photographer having the photographer ID=12, while the male friend B is the photographer having the photographer ID=11.

In the explanatory diagram illustrated in FIG. 7, and area A1 is the display area of the monitor instanced by the EL panel and other equivalent displays. The area A1 includes the display area of the subjects having the subject ID=2, the subject ID=3 and the subject ID=4 in the process of the images being captured. The area A1 includes a display area A3 of the subject having the subject ID=2, a display area A5 of the subject having the subject ID=3 and a display area A4 of the subject having the subject ID=4 in the process of the images being captured. An area A2 is a display area in which to display the advice character string with respect to the image photographing status in the process of capturing the image, and is displayed by being superposed on the area A1. The display area of the area A2 is disposed in an upper portion of the display area of the monitor instanced by the EL panel and other equivalent displays.

For example, the advice character string for the image photographing status in the process of capturing the image is displayed in the area A2 together with the effective sound, i.e., a chime sound B. The display method specified by “3” entered in the “set value” field is the method of displaying, e.g., the advice character string “the male friend B is nearby you. Ask the male friend B to photograph an image including you, will you?” in relation to the record specified by the list ID=3 in FIG. 6K. Also displayed is the advice character string “the male friend A is nearby you. Ask the male friend A to photograph an image including you, will you?” in relation to the record specified by the list ID=2 in FIG. 6K after an elapse of a fixed period of time on the seconds-basis such as 1 sec and 5 sec. The respective advice character strings to be displayed in the area A2 are sequentially displayed in the sequence from the highest of the point values of the records illustrated in FIG. 6K.

As discussed above, the image photographing assist system 1 according to the embodiment can recognize the subject information and the photographer information from the image information in the process of capturing the image. The image photographing assist system 1 according to the embodiment can specify the image photographing position of the imaging apparatus 10 in the process of capturing the image information, and is thereby enabled to specify other photographers located in the proximity distance range of the imaging apparatus 10. The image photographing assist system 1 according to the embodiment calculates the image photographing performance level on the individual basis from the image photographing numerical quantity, the image photographing period and the evaluations made by other persons, and is thereby enabled to perform the relative ranking of the levels of skill related to the image photographing. The image photographing assist system 1 according to the embodiment calculates the image photographing frequency of the subject that is photographed at the event and other equivalents as the subject frequency, and can calculate the subject point in which the skill level of the photographer is reflected with respect to the calculated subject frequency.

The image photographing assist system 1 can generate the status changeability such as changing the subject, the photographer and the image photographing position with respect to the image photographing status in the process of capturing the image as the change information to which the point is added based on the skill level of the photographer and the image photographing frequency of the subject composition containing the recognized subjects. The point calculated based on the difference from the skill levels of the photographers before and after being changed can be reflected in the point of the change information, and hence it is feasible to display the changeability to the image photographing by the image photographing enabled person exhibiting the high skill of image photographing. The point calculated based on the difference of subject point between the subject compositions before and after being changed, and it is therefore feasible to display the changeability for enhancing the image photographing possibility of the subject composition with the image photographing numerical quantity being small. The subject compositions before and after being changed contain the change of the image photographing position, and hence, for example, it is feasible to display the changeability of the image photographing position in the process of capturing the image when the image photographing place desirable for the image photographing opportunity exists in the place in close proximity to the image photographing position.

The subject compositions before and after being changed contain the change of the image photographing bearing, and it is therefore feasible to display the changeability taking account of setting a scene desirable for the image photographing opportunity as a background and a sunshine condition such as front light and backlight for the subject. The image photographing assist system 1 according to the embodiment can select the image photographing advice with respect to the image photographing status in the process of capturing the image, corresponding to how high or low the point value is, which is added to the change information. The image photographing assist system 1 according to the embodiment can display the selected image photographing advice to the photographer in the process of capturing the image information. As a result, the imaging apparatus 10 of the image photographing assist system 1 according to the embodiment can enhance the possibility to obtain the well-performed result of the image photographing, corresponding to the image photographing status in the process of capturing the image.

According to the imaging apparatus, it is feasible to provide the technology of acquiring the well-performed result of the image photographing.

<Non-Transitory Computer Readable Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM and other equivalent recording mediums are given as the non-transitory recording mediums fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An imaging apparatus comprising:
a memory; and
a processor coupled to the memory and the processor configured to perform:
transmitting an assist request for the imaging apparatus to an information processing apparatus, the information processing apparatus managing an image photographing skill on an individual basis and positional information of an apparatus associated with each of the individual;
acquiring, from the information processing apparatus, assist information containing existence information of an image photographing enabled person within a predetermined range from the imaging apparatus, the assist information being generated based on the image photographing skill and the positional information; and
outputting the acquired assist information to an output unit.

2. The imaging apparatus according to claim 1, wherein the assist information contains a suggestion for changing a subject contained in image information in a process of capturing performed by an imaging unit.

3. The imaging apparatus according to claim 1, wherein the assist information contains a suggestion for changing an image photographing position with respect to image information in a process of capturing performed by an imaging unit.

4. The imaging apparatus according to claim 1, wherein the assist information contains a suggestion for changing an image photographing direction with respect to image information capturing performed by an imaging unit.

5. The imaging apparatus according to claim 1, wherein the image photographing skill is calculated based on image photographing numerical quantities of image information captured, an image photographing period for capturing the image information and evaluations made by other persons about the image information.

6. An information processing apparatus comprising:
a memory; and
a processor coupled to the memory and the processor configured to perform:
first managing an image photographing skill on an individual basis of a person capturing image information on the basis of the image information accumulated in the memory;
second managing positional information of an apparatus associated with each of the individual; and
generating, based on the image photographing skill on the individual basis and the positional information in response to an assist request given from an imaging apparatus, assist information containing existence information of an image photographing enabled person within a predetermined range from the imaging apparatus.

7. An image photographing assist system comprising:
an imaging apparatus; and
an information processing apparatus,
the image photographing assist system being configured by connecting the imaging apparatus to the information processing apparatus,
the imaging apparatus including:
a first memory; and
a first processor coupled to the first memory and the first processor configured to perform:
transmitting an assist request for the imaging apparatus to the information processing apparatus, the information processing apparatus managing an image photographing skill on an individual basis and positional information of an apparatus associated with each individual; and
acquiring, from the information processing apparatus, assist information containing existence information of an image photographing enabled person within a predetermined range from the imaging apparatus, the assist information being generated based on the image photographing skill and the positional information, and
outputting the acquired assist information to an output unit,
the information processing apparatus including:
a second memory; and
a second processor coupled to the second memory and the second processor configured to perform:
first managing an image photographing skill on an individual basis of a person capturing image information on the basis of the image information accumulated in a storage unit;
second managing positional information of an apparatus associated with each individual; and
generating assist information containing existence information of an image photographing enabled person within a predetermined range from the imaging apparatus, based on the image photographing skill on the individual basis and the positional information in response to an assist request given from an imaging apparatus.

8. A non-transitory computer-readable recording medium storing a program that causes a computer to execute a process comprising:
transmitting an assist request for the imaging apparatus to an information processing apparatus, the information processing apparatus managing an image photographing skill on an individual basis and positional information of an apparatus associated with each of the individual;
acquiring, from the information processing apparatus, assist information containing existence information of an image photographing enabled person within a predetermined range from the imaging apparatus, the assist information being generated based on the image photographing skill and the positional information; and
outputting the acquired assist information to an output unit.

9. A non-transitory computer-readable recording medium storing a program that causes a computer to execute a process comprising:
first managing an image photographing skill on an individual basis of a person capturing image information on the basis of the image information accumulated in the memory;
second managing positional information of an apparatus associated with each of the individual; and
generating, based on the image photographing skill on the individual basis and the positional information in response to an assist request given from an imaging apparatus, assist information containing existence information of an image photographing enabled person within a predetermined range from the imaging apparatus.

10. An image photographing assist method in an image photographing assist system configured by connecting a plurality of imaging apparatuses to an information processing apparatus, the image photographing assist method comprising:
transmitting an assist request for an imaging apparatus to an information processing apparatus, the information processing apparatus managing an image photographing skill on an individual basis and positional information of an apparatus associated with each of the individual;
acquiring, from the information processing apparatus, assist information containing existence information of an image photographing enabled person within a predetermined range from the imaging apparatus, the assist information being generated based on the image photographing skill and the positional information;
outputting the acquired assist information to an output unit;
first managing an image photographing skill on an individual basis of a person capturing image information on the basis of the image information accumulated in a storage unit;
second managing positional information of an apparatus associated with each of the individual; and
generating, based on the image photographing skill on the individual basis and the positional information in response to an assist request given from an imaging apparatus, assist information containing existence information of an image photographing enabled person within a predetermined range from the imaging apparatus.
